(19) United States
(12) Patent Application Publication
(10) Pub. No.: US 2026/0164459 A1
(43) Pub. Date: Jun. 11, 2026

(54) METHODS AND SYSTEMS FOR NR SIDELINK RESOURCE ALLOCATION OVER SHARED SPECTRUM

(71) Applicant: InterDigital Patent Holdings, Inc., Wilmington, DE (US)

(72) Inventors: Rocco Di Girolamo, Laval (CA); Pascal Adjakple, Great Neck, NY (US); Allan Tsai, Boonton, NJ (US); Kyle Pan, Saint James, NY (US)

(73) Assignee: InterDigital Patent Holdings, Inc., Wilmington, DE (US)

(21) Appl. No.: 18/706,994

(22) PCT Filed: Nov. 16, 2022
(86) PCT No.: PCT/US2022/079981

§ 371 Date: May 2, 2024

Related U.S. Application Data
(60) Provisional application No. 63/264,125, filed on Nov. 16, 2021.

(51) Int. Cl. H04W 74/0808; H04W 72/25

(52) U.S. Cl. CPC H04W 74/0808; H04W 72/25

(57) ABSTRACT

Methods and systems are described herein for NR sidelink resource allocation over a shared spectrum. In an example, a UE may determine one or more candidate resources for sending a sidelink transmission. The UE may determine a state associated with each slot of one or more slots in a sensing window. The UE may further determine, based on the state associated with each of the one or more slots, one or more available slots. The UE may reserve, based on the one or more available slots, one or more resources of the one or more candidate resources. The UE may send, via one or more of the reserved resources, the sidelink transmission.

### CROSS-REFERENCE TO RELATED APPLICATIONS

This application claims the benefit of U.S. Patent Application No. 63/264,125, filed Nov. 16, 2021.

### BACKGROUND

Data usage in networks under the Fifth Generation (5G) New Radio (NR) standard is expected to be much greater than in previous iterations of wireless network technology. Therefore, innovations in data processing are required to meet such increased demands. Usage of unlicensed bands may allow for additional avenues to manage data throughput on NR networks. However, because unlicensed bands may be used by any user, there is a need for systems and methods that can effectively allocate resources to users transmitting on unlicensed bands.

### SUMMARY

Methods and systems are described herein for NR sidelink resource allocation over shared spectrum. Operating on shared spectrum may increase the data rates available in NR networks. Systems and methods described herein may provide a network with the ability to allocate resources to User Equipment's (UEs) on both licensed and unlicensed bands. The systems and methods described herein may provide a network with the ability to allocate resources to UEs on shared spectrum.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system.

FIG. 2 shows an example method.

FIG. 3 shows an example method.

FIG. 4 shows an example method.

FIG. 5 shows an example method.

FIG. 6 shows an example method.

FIG. 7 shows an example method.

FIG. 8 shows an example method.

FIG. 9 shows an example method.

FIG. 10 shows an example system.

FIG. 11 shows an example method.

FIG. 12 shows an example method.

FIG. 13A shows an example method.

FIG. 13B shows an example method.

FIG. 14 shows an example method.

FIG. 15 shows an example method.

FIG. 16A shows an example system.

FIG. 16B shows an example apparatus.

FIG. 16C shows an example system.

FIG. 16D shows an example system.

FIG. 16E shows an example system.

FIG. 16F shows an example system.

FIG. 16G shows an example system.

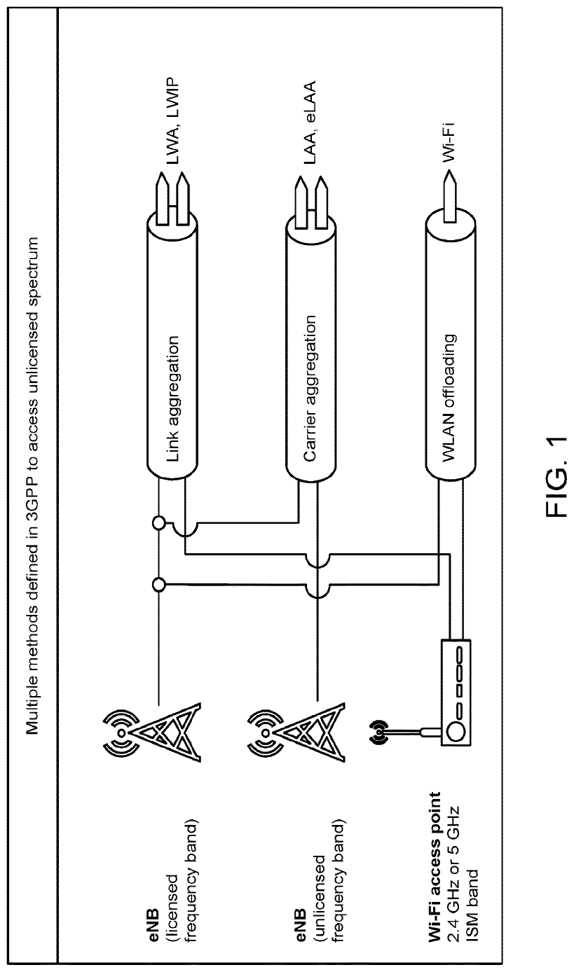

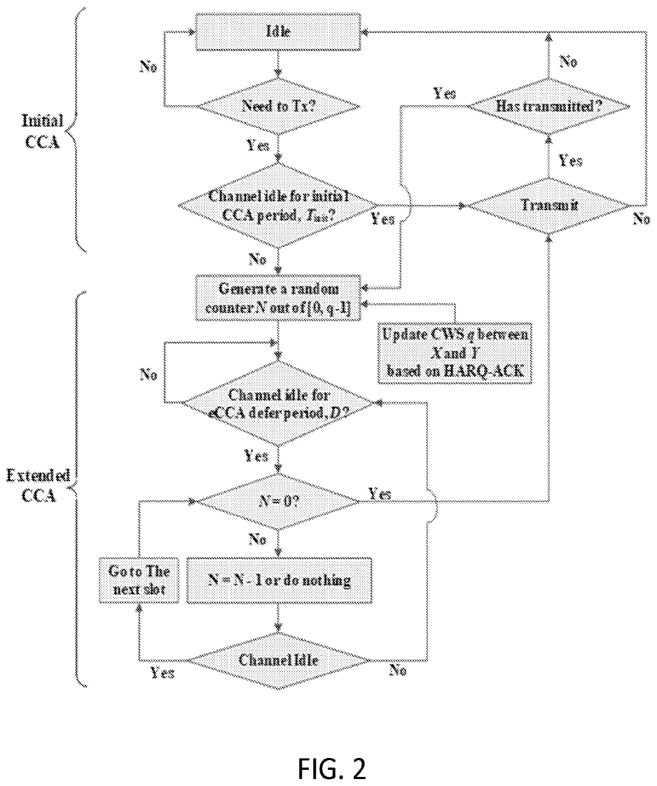

### DETAILED DESCRIPTION

Methods and apparatuses are described herein for sidelink resource allocation over shared spectrum.

The following abbreviations may be used herein:

| | |
|---|---|
| 3GPP | 3rd Generation Partnership Project |
| ACK | ACKnowledgement |
| AR | Augmented Reality |
| ARQ | Automatic Repeat reQuest |
| AUL | Autonomous UpLink |
| B-IFDMA | block interleaved frequency division multiplex |
| BSR | Buffer Status Report |
| CAT | CATegories (of LBT) |
| CCA | Clear Channel Assessment |
| CE | Control Element |
| COT | Channel Occupancy Time |
| CSI | Channel State Information |
| CW | Contention window |
| DAA | Detect And Avoid |
| DCI | Downlink Control Information |
| DFS | Dynamic Frequency Selection |
| DMTC | DRS measurement timing configuration |
| DRS | Discovery Reference Signal |
| DTX | Discontinuous Transmission |
| ED | Energy Detection |
| eNB | Evolved NB |
| ETSI | European Telecommunications Standards |
| | Institute |
| FCC | Federal Communications Commission |
| HARQ | Hybrid ARQ |
| HMD | Head Mounted Device |
| ISM | Industrial, Scientific and Medical |
| ITU | International Telecommunication Union |
| LAA | License Assisted Access |
| LBT | Listen-Before-Talk |
| LBTR | LBT Report |
| LTE | Long Term Evolution |
| LWA | LTE Wi-Fi Aggregation |
| MAC | Media Access Control |
| NACK | Negative ACK |
| NB | Node B (base station) |
| NCIS | Network Controlled Interactive Service |
| OFDM | Orthogonal Frequency Division Multiplexing |
| PDSCH | Physical Downlink Shared Channel |
| PHY | PHYsical |
| PQI | PC5 QoS Indicator |
| PRB | Physical resource Block |
| PSCCH | Physical sidelink Control Channel |
| PDSCH | Physical Downlink Shared Channel |
| PUSCH | Physical Uplink Shared Channel |
| RMTC | RSSI measurement timing configuration |
| RRM | radio resource management |
| RSSI | Received Signal Strength Indicator |
| RSRP | Reference Signal Received Power |
| RSRQ | Reference Signal Received Quality |
| RX | Receive/Receiver |
| SCI | Sidelink Control Information |
| SL | SideLink |
| SR | Scheduling Request |
| TB | Transport Block |
| TPC | Transmit power Control |
| TX | Transmit/Transmitter |
| UE | User Equipment |
| UL | UpLink |
| V2X | Vehicle to Everything |
| VR | Virtual Reality |
| XR | extended reality |

The following definitions may be used herein:

LBT failure: A transmission attempt over unlicensed spectrum that results in a failure. The transmission may not be made because the channel is in use by another user. The another user may be from the same system or from a different system, and the another use may be using the same technology or different technology. An LBT failure applies to a given transmission.

LBT success: A transmission attempt over unlicensed spectrum that results in a success. The transmitter has sensed the channel and determined that no other user is using the channel. The another user may be from the same system or from a different system, and the another user may be using the same technology or different technology. An LBT success applies to a given transmission.

LBT attempt: A transmission attempt to access a channel. The result of an LBT attempt may be either an LBT success or LBT failure. An LBT attempt applies to a given transmission.

LBT operation: Refers to steps in which a UE performs a Clear Channel Assessment (CCA) and determines whether the channel is free or busy. If the channel is free the LBT is successful. If the channel is busy, the LBT is a failure.

LBT state: The ongoing state of the channel that is to be used for transmission, A channel may be in at least 2 states: busy or free. When the LBT state of a channel is “busy,” transmission attempt may result in LBT failures. When the LBT state of a channel is “free,” transmission attempt may result in LBT successes.

Delayed transmissions: as part of NR-U standardization, the notion of pending HARQ processes was introduced, to allow for the case that transmissions of HARQ processes may result in LBT failures. The transmissions of the pending HARQ processes are delayed and are attempted in future configured uplink grants.

Unlicensed spectrum/unlicensed bands: Radio Spectrum, in general, may be categorized into two types, a) licensed—assigned exclusively to operators for independent usage, b) unlicensed—assigned to every citizen for non-exclusive usage subject to some regulatory constraints, for example restrictions in transmission power etc.

Shared Spectrum: Spectrum that is shared and may be used by multiple categories of users. Some coexistence mechanism is required to allow the sharing of spectrum (e.g. listen before talk). Shared spectrum is typically unlicensed. However, it is also possible to share licensed spectrum.

Resource (re)selection sensing: Sensing that is done as part of Mode 2 resource allocation, to find resources in the future. UE reads the SCI and knows about future reservations (these are for retransmissions as well as new transmissions). Sensing occurs in a resource pool. Resource (re)selection sensing may be based on slots.

LBT sensing: Sensing to determine LBT state of a channel—to determine if channel is free. Although not specified when LBT sensing occurs, LBT sensing may be needed when a UE performs a transmission. When a UE undergoes LBT sensing, the UE would determine whether a channel is being used by another terminal. LBT sensing is based on “sensing slots”.

NR Sidelink may be contemplated for multiple use cases, including: 1) NR V2X sidelink: In one use case, information is to be provided to vulnerable road users, e.g., pedestrian or cyclist, about the presence of moving vehicles in case of dangerous situations, 2) NR Commercial (non-V2X) sidelink: In one use case (Proximity based applications Augmented Reality/Virtual Reality (AR/VR)), sidelink communications with high throughput and low latency may be required. For example, a head mounted device VR unit may have a sidelink to offload computing to a gateway device. 3) NR Critical (non-V2X) sidelink: Some critical/emergency situations may require SL communications with little or no cellular coverage, and with first responders using UEs for extended periods of time to communicate with each other and to send out location information. Power savings for first responders is an important factor.

Increased data rates may be required by advanced V2X scenarios and also commercial sidelink use cases other than V2X.

In TS 22.186, the requirement of sensor information sharing between UEs is defined as 1000 Mbps data rate with a reliability of 99.99%. Additionally, new services for users to exchange information and play games are expected to become more and more popular (e.g., NCIS: Network Controlled Interactive Service). TR 22.842 captured several typical use cases for NCIS. The interactive services may happen between local users via sidelink where the local users could be AR/VR enabled phones or glasses, 3D-gaming equipment, and other HMDs. The required data rate is very high (e.g., several Gbps) as defined in TR 22.842. In current sidelink, the spectrum may be too limited to achieve the higher data rate requirements.

XR and gaming is the acknowledged killer application for glasses, Head Mounted Displays (HMDs), or the like. SA1 has identified the use cases and requirements in Network Controlled Interactive Services: NCIS (TR 22.842).

Sidelink is identified as an important use case for XR, for example, for consuming VR content via tethered VR headsets in the interactive service. SA2 has defined the corresponding PQI for such kinds of requirements, where end-to-end latency is 5-10 msec and the required data rate requirement is 0.1-10 Gbps with reliability 99.99%.

TABLE 1
New Services for SL

| | | | | | Default | | |
|---|---|---|---|---|---|---|---|
| | | | | | Maximum | | |
| | | Default | Packet | Packet | Data | Default | |
| PQI | Resource | Priority | Delay | Error | Burst | Averaging | Example |
| Value | Type | Level | Budget | Rate | Volume | Window | Services |
| New | Delay | 5 | 5 ms | 10\hat{ }−4 | 20000 | 2000 msec | Interactive |
| value#1 | Critical | | | | bytes | | service - |
| | GBR | | | | | | consume |
| | | | | | | | VR content |
| | | | | | | | with high |
| | | | | | | | compression |
| | | | | | | | rate via |
| | | | | | | | tethered VR |
| | | | | | | | headset |
| New | | 6 | 10 ms | 10\hat{ }−4 | 20000 | 2000 msec | interactive |
| value#2 | | | | | bytes | | service - |
| | | | | | | | consume |
| | | | | | | | VR content |
| | | | | | | | with low |
| | | | | | | | compression |
| | | | | | | | rate via |
| | | | | | | | tethered VR |
| | | | | | | | headset; |
| | | | | | | | Gaming or |
| | | | | | | | Interactive |
| | | | | | | | Data |
| | | | | | | | Exchanging; |

RAN1 evaluated and concluded that the current release of NR sidelink may not support the required data rate. Further, currently there is no suitable spectrum/bandwidth to support this kind of commercial service.

The ability to operate using unlicensed spectrum is desired. Standardization discussion started in the R13 time frame. As part of Release 13, there was a study Item “Study on Licensed-Assisted Access Using LTE”. The amount of data traffic carried over cellular networks was increasing at a very fast rate and is expected to increase for many years to come. The number of users/devices was increasing and each user/device was accessing an increasing number and variety of services, for example video delivery. The increase in data traffic required not only high capacity in the network, but also provisioning very high data rates to meet users' expectations on interactivity and responsiveness. More spectrum was therefore needed for cellular operators to meet the increasing demand. The preferred type of spectrum to efficiently serve users is licensed spectrum. Licensed spectrum may deliver predictable high-quality services with the highest spectral efficiency. In addition, in order to deliver predictable services, mobile operators may need to perform heavy network investments, through careful planning and deployment of high-quality network equipment and devices. The justifications for such extensive capital investments require the reliability and operational assurance enabled by licensed spectrum. It is therefore essential that the regulatory community continues focusing on identifying and allocating new licensed spectrum that may be utilized specifically for mobile communications.

Striving to meet the market demands, there was increasing interest from operators in deploying complementary access utilizing unlicensed spectrum to meet the traffic growth. For example, a large number of operator-deployed Wi-Fi networks and the 3GPP standardization of LTE/WLAN interworking solutions. The interest indicated that unlicensed spectrum, when present, could be an effective complement to licensed spectrum, for cellular operators to help address the traffic explosion in some scenarios, such as hotspot areas. A number of open questions needed to be addressed: Question 1: Which unlicensed spectrum may be targeted?Question 2: How 3GPP UEs would “use” the unlicensed spectrum?

Initially, the cellular industry, led by several network operators, infrastructure vendors and chipset manufacturers, focused on the 5 GHz industrial, scientific, and medical (ISM) band, to serve the immediate need for additional spectrum for mobile broadband applications due to the ever increasing mobile data traffic.

The ISM bands are generally defined by the International Telecommunication Union (ITU) Radio Regulations (Article 5), but are regulated differently by each region (e.g. European Telecommunications Standards Institute (ETSI) in Europe or Federal Communications Commission (FCC) in USA).

The exact frequency allocation and detailed regulation depends on the country (for example, South Korea vs. Japan). Note, the allocations are not exactly the same in each country and there are different rules depending on country. For example with respect to: DFS (dynamic frequency selection), indoor/outdoor use, TPC (transmit power control), and the like. Additionally, rules exist for: 1) Power spectral density limits. 2) Channel access and occupation rules: The equipment implements an adequate spectrum sharing mechanism in order to facilitate sharing between the various technologies and applications. The adequate spectrum sharing mechanism may be, for example LBT (Listen Before Talk), DAA (Detect And Avoid). 3) Discontinuous transmission (for example, in Japan).

Multiple standardized solutions were developed to use the unlicensed band: 1) LWA (LTE Wi-Fi Aggregation): enables utilizing both LTE and Wi-Fi links simultaneously, without requiring hardware changes to the network infrastructure equipment and mobile devices. LWA leverages carrier Wi-Fi deployments based on a dual connectivity architecture, where Wi-Fi is used instead of a secondary LTE eNB. 2) LAA: extension of LTE to unlicensed spectrum based on carrier aggregation, which has been standardized by 3GPP. 3) WLAN Offloading: 3GPP traffic offloaded to WiFi.

LBT is a contention mechanism where the transmitter checks the channel state before using the channel. LBT relies mainly on a clear channel assessment procedure (CCA) with energy detection (ED) threshold to sense the channel state for a defer period, and to determine whether any signal (regardless of its kind) is present above a certain power value. As the channel is detected free, the station may be allowed to transmit. Otherwise the station must wait for a backoff period of time determined by a Contention Window (CW).

Before standardization by 3GPP, several variants or categories (CAT) of LBT were considered: Category 1: No LBT procedure is performed. Category 2: LBT without random backoff with deterministic waiting time when the channel is found free. Category 3: LBT with random backoff and fixed contention window size. Category 4: LBT with random backoff and variable contention window size (between some minimum and maximum).

The need to ensure fair sharing and coexistence with other technologies made it necessary to introduce frame structure type 3. It is applicable to LAA secondary cell operation with normal cyclic prefix only. The radio frame duration for frame structure type 3 remains 10 ms. The 10 subframes within a radio frame are available for downlink transmissions. Downlink transmissions occupy one or more consecutive subframes, starting anywhere within a subframe and ending with the last subframe either fully occupied or following one of the DwPTS durations. In the literature, this is sometimes called an LAA burst. All 10 subframes [1 ms each] are available for downlink transmission, where a transmission may occupy one or more consecutive subframes, starting within a subframe at the first or second slot boundaries. The transmission also does not need to end with the subframe. Instead, the downlink pilot time slot (DwPTS) architecture from frame structure type 2 (TDD) is reused. Thus, the last subframe of the “LAA radio frame” may either be fully occupied or follow one of the DwPTS durations.

Even though a LAA burst may span multiple subframes, the scheduling Downlink Control Information DCI (DCI1, DCI2, DCI2A etc) may be being transmitted at every subframe that carries Physical Downlink Shared Channel (PDSCH). Information on starting and stopping points may be carried in DCI. To provide the additional information to UEs, DCI format 1C is used. The rules: i) If there is regular scheduling DCI only DCI (DCI1, DCI2, DCI2A etc), it is assumed that all the symbols in the subframe are carrying LAA data. ii) If there is both regular scheduling DCI and DCI 1C, the subframe(current subframe) or next subframe may or may not be a partial subframe (subframe carrying data in less than 14 Orthogonal Frequency Division Multiplexing (OFDM) symbols). iii) If there is no DCI at all, the subframe does not transmit any LAA data.

LAA applies CCA in two steps: an initial CCA and an enhanced (or extended) CCA. In LAA, CCA is based on energy detection (ED) over a defined time duration, that does not exceed a certain threshold value (ED threshold). Research occurred on the value of the threshold, but in the end a fixed threshold was adopted. The detected energy level must to be below the threshold for a certain amount of time with a sensing slot duration Tsl and defer time Td. Td depends on the priority of the traffic. If the channel is sensed to be clear, the transmitter may only transmit for a limited amount of time defined as the maximum channel occupancy time (COT) (Tm cot,p). Maximum channel occupancy time (COT) depends on the priority of the traffic. If the channel is sensed to be occupied during that time or after a successful transmission, the “enhanced (or extended) CCA” period is started by generating a random number ‘N’ that is within the contention window (CW). CW is within a range that depends on the priority of the traffic. For enhanced CCA: UE decrements N for each slot that the channel is sensed free. When N=0, UE may transmit.

The variables of LBT procedure depend on priority of traffic. Also note that the counter N is impacted by the HARQ process. If more than 80% of all transmissions in reference subframe k are NACK/DTX, CW is incremented to the next possible value. For example, for priority class 3, if CW is initially 15, the next value would be be 31 as per the allowed CW sizes shown in Table 2 for downlink or Table 3 for uplink.

TABLE 2
Channel Access Priority Class (CAPC) for Downlink Channel Access

| Channel | | | | | |
|---|---|---|---|---|---|
| Access | | | | | |
| Priority | | | | | |
| Class | | | | | allowed |
| (p) | mₚ | CW_{min, p} | CW_{max, p} | T_{m cot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, 255, 511, 1023} |
| | | | | ms | |

TABLE 3
Channel Access Priority Class (CAPC) for UL Channel Access

| Channel | | | | | |
|---|---|---|---|---|---|
| Access | | | | | |
| Priority | | | | | |
| Class | | | | | allowed |
| (p) | mₚ | CW_{min, p} | CW_{max, p} | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 | {15, 31, 63, 127, 255, 511, 1023} |
| | | | | ms | |
| 4 | 7 | 15 | 1023 | 6 ms or 10 | {15, 31, 63, 127, 255, 511, 1023} |
| | | | | ms | |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap may be 100 us. The maximum duration before including any such gap may be 6 ms.

The Discovery Reference Signals (DRS) are a set of signals that includes the Primary Synchronization Signal, the Secondary Synchronization Signal, the Cell-specific Reference Signal, and the Channel State Information Reference Signal (if configured). DRS transmission may be utilized in LAA for cell detection, synchronization, and radio resource management (RRM) measurement. Similar to the Rel-12 DRS, LAA DRS may be transmitted within a periodically occurring time window called the DRS measurement timing configuration (DMTC) occasion. However, to reduce a collision probability, the transmission of DRS may also be subject to LBT. DRS may be transmitted following a single idle observation interval of at least 25 μs. To compensate for potential DRS transmission blocking due to LBT and increase the probability of successful DRS transmission, the network may be allowed to attempt DRS transmission in any subframe within the DMTC occasion.

Channel selection for LAA may be important for coexistence with other RATs such as Wi-Fi. For example, LAA may try to avoid frequencies that are more congested with Wi-Fi [access points/station (APs/STAs)] and RRM measurements are critical for the purpose. In legacy LTE operation, Reference Signal Received Power (RSRP), Received Signal Strength Indicator (RSSI), and Reference Signal Received Quality (RSRQ) may be specified and only RSRP and RSRQ may be reported to an eNB by a UE. RSSI may serve as a metric for the interference strength on a carrier, and it is possible to infer RSSI from RSRP and RSRQ reports. However, if the DRS is not transmitted by the eNB on a carrier, for example due to LBT, RSRP and RSRQ reports may not be available. As a result, RSSI measurement reports along with time information about when the measurements were made by a UE are useful for hidden node detection at an LAA eNB. The absolute RSSI level observed by a UE as well as statistics of RSSI distribution during a measurement period are useful to provide a more complete picture of the load on a carrier and assist in hidden node detection by correlating measurements made by one or more UEs with those made by the eNB. As a result, LAA has introduced new measurements of average RSSI and channel occupancy (percentage of time that RSSI was observed above a configured threshold) for RRM reports. To this end, a RSSI measurement timing configuration (RMTC) may be configured to indicate a measurement duration (e.g. 1-5 ms) and period between measurements (e.g. {40, 80, 160, 320, 640}ms).

LBT may also be mandatory for uplink channel access. Rel-14 eLAA supports two types of uplink channel access procedures. Type 1 uplink channel access procedure is analogous to the one for downlink channel access in Rel-13 LAA where a series of slots for CCA have to be sensed as clear on a channel before a UE transmits on the channel. The number of slots may be generated from a CWS that is adaptively adjusted by a UE. Four types of priority classes are also supported in the uplink; however, particular values for MCOT and CWS are different from the ones in downlink. Type 2 uplink channel access procedure is analogous to the one for Discovery Reference Signals (DRS) transmission where a UE performs CCA over only a short period. The duration of the period is fixed to be at least 25p s. For transmission of a Physical Uplink Shared Channel (PUSCH), an eNB may indicate to a ULE the type of channel access procedure through an uplink grant scheduling the PUSCH transmission. In general, type 1 uplink channel access procedure is utilized to initialize a MCOT containing PUSCH transmission, while type 2 uplink channel access procedure is utilized within the MCOT for resuming a suspended transmission or for changing the transmission direction from downlink to uplink.

In addition, in order to meet some regulatory requirements, there was a need for a new uplink waveform for eLAA. For example, the European Telecommunication Standardization Institute (ETSI) mandates that the occupied channel bandwidth, defined by 3GPP to be the bandwidth containing 99% of the power of the signal, shall be between 80% and 100% of the declared nominal channel bandwidth. 3GPP adapted the principle of block interleaved frequency division multiplex (B-IFDMA) for eLAA.

COT sharing is a mechanism (enabled by ETSI-BRAN) wherein one device acquires a COT using usual CAT4 LBT and another device shares it using a 25 μs LBT with a gap provided the amount of transmission does not exceed the MCOT limit for the given priority class.

For eNB to UE COT sharing, the purpose of the mechanism allows LAA UL in which an eNB sends a grant to the UE before the UE transmits on the UL and the delay between the grant and the corresponding UL transmission is at least 4 ms. For a ULE to use the shared COT for Autonomous UL (AUL) transmissions, the following rule applies: the eNB may indicate using the ‘UL duration and offset’ field and ‘COT sharing indication for AUL’ field that a UE configured with autonomous UL may perform a Type 2 channel access procedure for autonomous UL transmissions(s) including PUSCH on a channel in subframe n when: the eNB has transmitted on the channel according to the channel access procedure described in clause 4.1.1 of TS 37.213 (that is a Type 1 DL channel access procedure), eNB acquired the channel using the largest priority class value, and eNB transmission includes PDSCH.

For UE to eNB COT sharing, many companies in 3GPP proposed that any COT acquired by a UE for Autonomous UpLink (AUL) transmission, if not fully exhausted, may be allowed to be shared with the eNB that in turn may use it for transmission of control or data UE to any UE with a pause and just 25 μs LBT as long as the eNB transmits for the minimum duration required to transmit data of equal or higher priority. In the end however, the conditions for an eNB to share a COT initiated by a UE are much more restrictive: For the case where an eNB shares a channel occupancy initiated by a UE, the eNB may transmit a transmission that follows an autonomous PUSCH transmission by the UE as follows: If ‘COT sharing indication’ in AUL-UCI in subframe n indicates ‘1’, an eNB may transmit a transmission in subframe n+X, where X is subframeOffsetCOT-Sharing, including PDCCH but not including PDSCH on the same channel immediately after performing Type 2A DL channel access procedures in clause 4.1.2.1 of TS 36.300, if the duration of the PDCCH is less than or equal to duration of two OFDM symbols and it may contain at least AUL-DFI or UL grant to the UE from which the PUSCH transmission indicating COT sharing was received.

For SL, transmission resources may be allocated to the UE by the gNB (for e.g., NR mode 1 resource allocation) or may be autonomously selected by the UE (for e.g., NR mode 2 resource allocation). Autonomous resource selection by the UE may be performed randomly or may be based on sensing. From hereinafter, UE autonomous resource selection may be denoted sensing-based resource selection and may be interchangeably denoted mode 2 resource allocation or mode 2 sensing-based resource allocation.

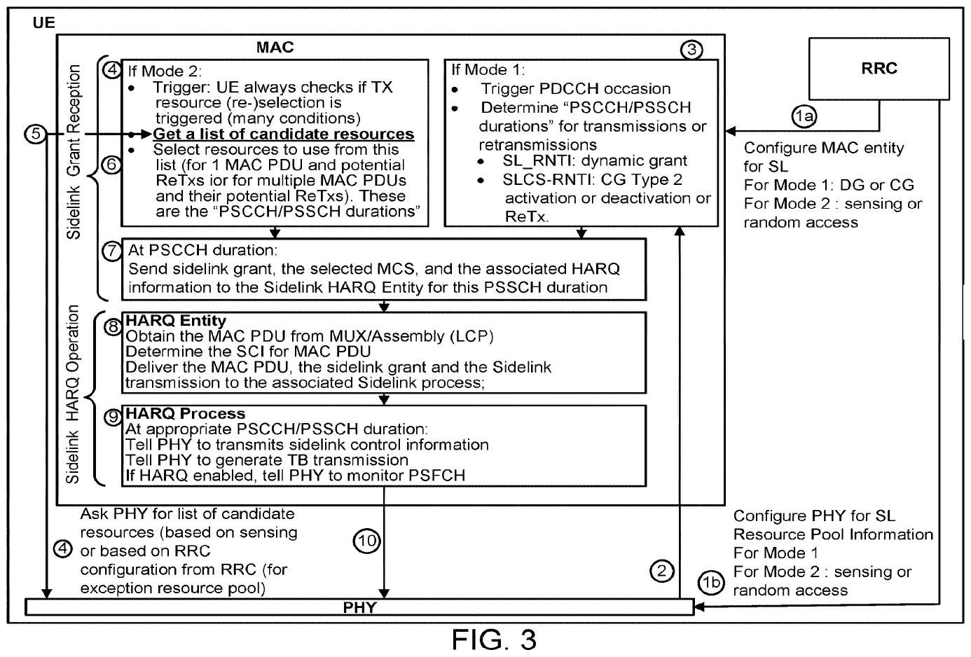

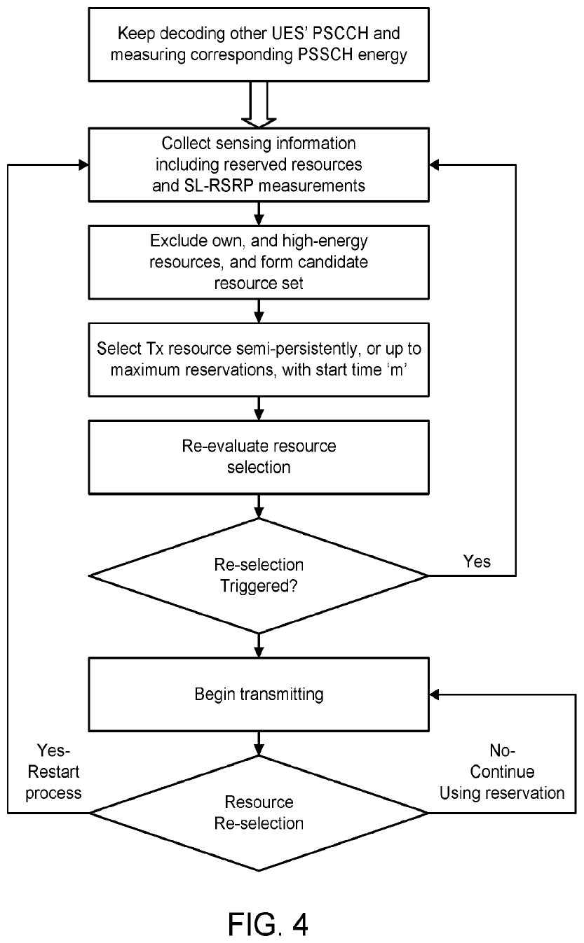

The basic process for resource allocation is shown in FIG. 3 and described below: Step 1a: The RRC configures the MAC entity for sidelink operation. This includes if the MAC entity is to use resource allocation mode 1 (either dynamic grants or configured grants) or resource allocation mode 2 (either based on sensing or based on random selection). Resource allocation mode 2 based on random selection is targeting exception resource pools. Step 1b: The RRC configures the PHY entity for sidelink operation. This includes the TX resource pool configuration, as well as mode 1 configuration, and mode 2 configuration. For the latter, the RRC may include the sensing configuration.

Step 2: The PHY informs the MAC layer when it receives DCI in the PDCCH occasion. The Sidelink Grant Reception determines the sidelink grant for UE At the MAC layer, the transmission opportunities for these sidelink grants are referred to as PSCCH/PSSCH durations.

If configured for mode 1 Operation: Step 3: The Sidelink Grant Reception determines if the PDCCH occasion has a sidelink grant. This is determined if the DCI is destined for SL-RNTI or SLCS-RNTI. The former is used for dynamic grants, while the latter is used for configured grant Type 2—namely activation, deactivation, or to schedule a retransmission for a Configured grant transmission.

If configured for mode 2 Operation: Step 4: In mode 2, the transmitting UE needs to continually evaluate which PSCCH/PSSCH durations may be used for a single MAC PDU transmission, for multiple MAC PDU transmissions, and the potential retransmissions of these MAC PDUs. To accomplish this, the Sidelink Grant Reception continually evaluates if TX resource (re)selection is necessary. A number of triggers may tell the MAC layer that it needs to find new PSCCH/PSSCH durations. For example, there is a reconfiguration of the Tx resource pools, there is new traffic that has no opportunity to be transmitted on sidelink, the PSCCH/PSSCH durations have not been used for an extended period of time, or the like.

Step 5: In order to assist the Sidelink Grant Reception, the MAC layer asks the PHY layer to provide a set of potential resources. The potential resources are provided by the PHY layer (based on sensing). This is referred to as the Candidate Resource set.

Step 6: The Sidelink Grant Reception randomly selects from this provided set of potential resources—in order to satisfy the transmission of one MAC PDU, multiple MAC PDUs, and the potential retransmissions of these MAC PDUs. The selected set denote the PSCCH/PSSCH durations for transmission.

Step 7: At the PSCCH/PSSCH duration, the Sidelink Grant Reception selects the MCS for the sidelink grant and sends the sidelink grant, the selected MCS, and the associated HARQ information to the Sidelink HARQ Entity for this PSSCH duration.

Step 8: The Sidelink HARQ entity, obtains the MAC PDU from Multiplexing and Assembly process. This is where Logical Channel Prioritization (LCP) occurs. The Sidelink HARQ entity, also determines the sidelink control information for MAC PDU, and delivers the MAC PDU, the sidelink grant and the Sidelink transmission information to the associated Sidelink process.

Step 9-10: The Sidelink Process, at appropriate PSCCH/PSSCH duration, tells the PHY to transmit SCI and tells the PHY to generate a transport block transmission. If HARQ is enabled, Sidelink Process also tells the PHY to monitor PSFCH.

Resource pools are (pre-)configured to a UE separately from the transmission perspective (TX pools) and the reception perspective (RX pools). This allows a UE to monitor for PSCCH, and hence receive PSSCH transmissions, in resource pools other than those in which the UE transmits, so they UE may attempt to receive transmissions made by other UEs in those RX pools. PSCCH and PSSCH resources are defined within resource pools for the respective channels. This concept is used because in general PSCCH/PSSCH may not be transmitted (and thus are not expected to be received) in all RBs and slots in the NR system bandwidth, nor within the frequency span configured for V2X sidelink. The notion of a resource pool also reflects, in resource allocation mode 2, that a UE may make its resource selections based on sensing within the pool.

In NR, a resource pool is divided into sub-channels in the frequency domain, which are consecutively non-overlapping sets of ≥10 PRBs in a slot, the size depending on (pre-)configuration. Resource allocation, sensing, and resource selection and reselection are performed in units of a sub-channel. The UE's PSCCH occupies a (pre-)configurable number of PRBs within one sub-channel, starting from the lowest PRB of the PSSCH it schedules.

The basic structure for UE autonomous resource selection is of a UE sensing within a (pre-)configured resource pool, which resources are not in use by other UEs with higher priority traffic and choosing an appropriate amount of such resources for its own transmissions. Having selected such resources, the UE may transmit and re-transmit in them a certain number of times, or until a cause of resource reselection is triggered.

The mode 2 sensing procedure may select and reserve resources for a variety of purposes reflecting that NR V2X introduces sidelink HARQ in support of unicast and groupcast in the physical layer. The procedure may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block, in a manner similar to the LTE-V2X scheme (clause 5.2.2.2 of TS 38.321). Finally, an initial transmission of a transport block may be performed after sensing and resource selection, but without a reservation.

The first-stage SCIs transmitted by UEs on PSCCH indicate the time-frequency resources in which the UE transmits a PSSCH. These SCI transmissions are used by sensing UEs to maintain a record of which resources have been reserved by other UEs in the recent past. Sidelink control information (SCI) in NR V2X may be transmitted in two stages. The first-stage SCI may be carried on PSCCH and contains information to enable sensing operations, as well as information about the resource allocation of the PSSCH. PSSCH transmits the second-stage SCI and the SL-SCH transport channel. The second-stage SCI carries information needed to identify and decode the associated SL-SCH, as well as control for HARQ procedures, and triggers for CSI feedback, etc. SL-SCH carries the TB of data for transmission over SL.

When a resource selection is triggered (e.g., by traffic arrival or a re-selection trigger), the UE may consider a sensing window which starts a (pre-)configured time in the past until shortly before the trigger time. The window may be, for example, either 1100 ms or 100 ms wide, with the intention that the 100 ms option is particularly useful for aperiodic traffic, and 1100 ms particularly for periodic traffic. A sensing UE also measures the SL-RSRP in the slots of the sensing window, which implies the level of interference which would be caused and experienced if the sensing UE were to transmit in them. In NR-V2X, SL-RSRP is a (pre-)configurable measurement of either PSSCH-RSRP or PSCCH-RSRP.

The sensing UE selects resources for its (re-)transmission(s) from within a resource selection window. The window starts shortly after the trigger for (re-)selection of resources, and cannot be longer than the remaining latency budget of the packet due to be transmitted. Reserved resources in the selection window with SL-RSRP above a threshold may be excluded from being candidates by the sensing UE, with the threshold set according to the priorities of the traffic of the sensing and transmitting UEs. Thus, a higher priority transmission from a sensing UE may occupy resources which are reserved by a transmitting UE with sufficiently low SL-RSRP and sufficiently lower-priority traffic.

If the set of resources in the selection window which have not been excluded is less than a certain proportion of the available resources within the window, the SL-RSRP exclusion threshold set according to the priorities (PPPP) of the traffic of the sensing and transmitting UE, is relaxed in 3 dB steps. The proportion is set by (pre-)configuration to 20%, 35%, or 50% for each traffic priority. The UE may select an appropriate amount of resources randomly from the non-excluded set. The resources selected are not in general periodic. Up to three resources may be indicated in each SCI transmission, which may each be independently located in time and frequency. When the indicated resources are for semi-persistent transmission of another transport block, the range of supported periodicities is expanded compared to LTE-V2X, in order to cover the broader set of envisioned use cases in NR-V2X.

Shortly before transmitting in a reserved resource, a sensing UE may re-evaluate the set of resources from which the UE may select, to check whether the UE's intended transmission is still suitable, taking account of late-arriving SCIs due, typically, to an aperiodic higher-priority service starting to transmit after the end of the original sensing window. If the reserved resources would not be part of the set for selection at T3, new resources are selected from the updated resource selection window. The cut-off time T3 is long enough before transmission to allow the UE to perform the calculations relating to resource re-selection.

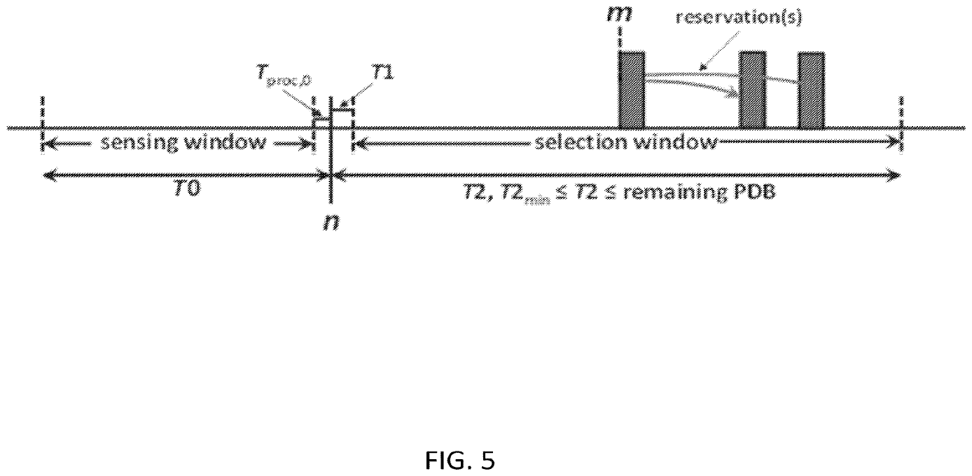

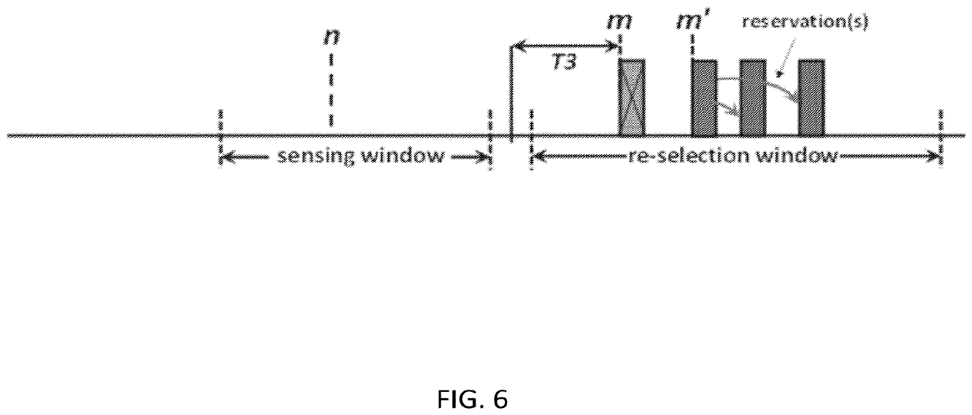

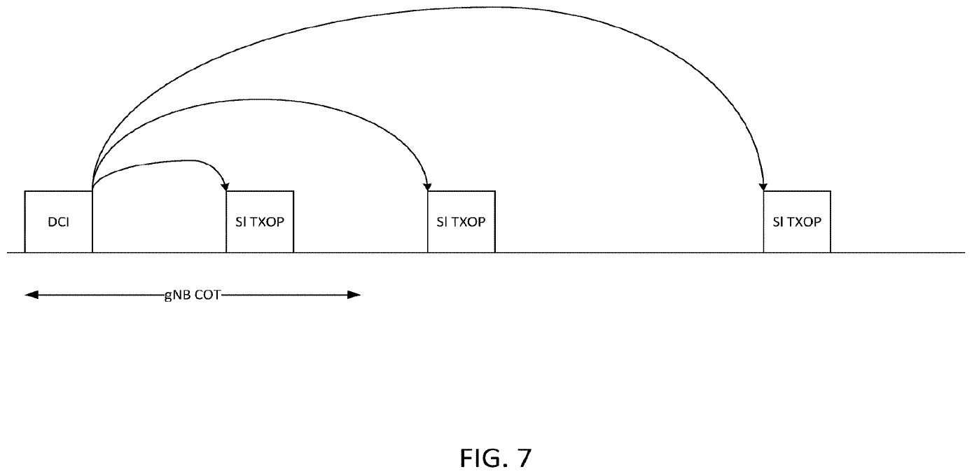

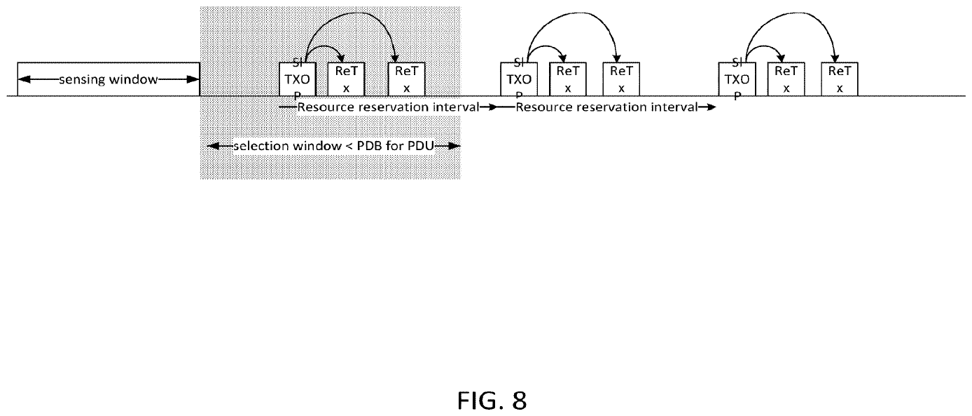

The timeline of the sensing and resource (re-)selection windows with respect to the time of trigger n, are shown in FIG. 5, and the effect of the possibility of re-evaluation before first use of the reservation in FIG. 6.

There are a number of triggers for resource re-selection. The triggers are designed to support high mobility and ensure that a UE does not assume occupation of a resource for an excessive period, nor when the selected resource is either insufficient or excessive for what is needed by the UE's traffic, amongst other causes. In addition, there is the possibility to configure a resource pool with a pre-emption function designed to help accommodate aperiodic sidelink traffic, so that a UE reselects all the resources it has already reserved in a particular slot if another nearby UE with higher priority indicates it may transmit in any of the slots, implying a high-priority aperiodic traffic arrival at the other UE, and the SL-RSRP is above the exclusion threshold. The application of pre-emption may apply between all priorities of data traffic, or only when the priority of the pre-empting traffic is higher than a threshold and higher than that of the pre-empted traffic. A UE does not need to consider the possibility of pre-emption later than time T3 before the particular slot containing the reserved resources.

In order to allow sidelink operation over unlicensed bands, the following areas may need to be addressed: 1) What is the overall resource allocation mechanism in unlicensed bands? 2) What is the impact of the unlicensed band and LBT on the MAC procedures?Issues related to the first area are the main focus presented herein. A first issue that needs to be solved relates to the impact of unlicensed spectrum operation on Mode 1 SL Resource allocation procedure.

Sidelink resource allocation Mode 1, allows a gNB to schedule sidelink transmissions of a UE. Two types of grants may be provided (a sidelink dynamic grant and a sidelink configured grant).

A sidelink dynamic grant DCI may provide resources for one or multiple transmissions of a transport block, in order to allow control of reliability. A sidelink configured grant may be such that the sidelink configured grant is configured once and may be used by the UE immediately, until the sidelink configured grant is released by RRC signaling (known as Type 1). A sidelink configured grant (known as Type 2) may be semi-statically activated and deactivated through MAC signaling.

The gNB scheduling activity may be driven by the UE reporting sidelink traffic characteristics to the gNB (for example through SidelinkUEInformationNR), and/or by performing a sidelink BSR procedure similar to that on Uu to request a sidelink resource allocation from gNB.

A number of problems occur when Mode 1 SL resource allocation procedure is performed through unlicensed spectrum.

For Resource allocation model, the gNB may provide dynamic grants to the UE for its SL transmissions. The dynamic grant may be used by the UE to determine PSCCH duration(s) and PSSCH duration(s) for an initial transmission and/or one or more retransmissions. The SL channel access procedure is not necessarily the same for each PSCCH duration. Note that the maximum COT size for DL is 8 ms, while a DCI may schedule a SL TXOP up to 31 slots in advance. This results in a case where one or more of the PSCCH durations may be in a shared COT. However, the UE may not be aware of which SL channel access procedure to use for each of the PSCCH duration(s). If a SL LBT failure occurs for a PSCCH duration(s), the UE procedure is not defined. If a SL LBT failure occurs for one of the PSCCH duration(s), the UE procedure for the remaining PSCCH duration(s) is not defined.

A further complication occurs if the Uu interface also uses unlicensed spectrum. The timing of the SL TXOPs is based on the relative timing of the DCI transmission. However, the DCI transmission may itself be subject to DL channel access procedure and its transmission may be delayed. This may in turn impact the UE determination of the SL TXOPs, resulting in potential collisions for the SL transmissions.

For Resource allocation model, the UE may rely on configured grants to determine SL TXOPs. These SL TXOPs may also lead to SL LBT failures. In addition, a sidelink grant addressed to SLCS-RNTI with NDI=1 is considered as a dynamic sidelink grant and would suffer from the same issues as a dynamic grant.

For the configured grant type 2 activation, an additional problem occurs if the Uu interface is unlicensed. In such cases, the time of the configured grant activation at the UE is based on the relative timing of the DCI transmission. However, the DCI transmission may itself be subject to DL channel access procedure and its transmission may be delayed. This may in turn impact the UE determination of the start of the configured grant, resulting in loss of SL transmission opportunities.

A second issue that needs to be solved relates to the impact of unlicensed spectrum operation on Mode 2 SL Resource allocation procedure.

For resource allocation mode 2, the UE autonomously determines the resources to use for SL transmissions. The MAC layer chooses the resources (for an initial transmission and possible retransmission) from a candidate resource set provided by the PHY layer. The PHY layer relies on sensing to determine the candidate resource set. The MAC layer may also reserve future resources (separated by the resource reservation interval). In unlicensed bands, there are 2 sensing procedures that are part of SL transmission: LBT sensing and resource (re)selection sensing. How the sensing procedures interact may not be defined. The two sensing procedures may be independent or concurrent. If independent, either may be done first. If no special processing is undertaken in unlicensed bands, the resources in the candidate resource set as well as the future periodic resources, may all undergo LBT failure. As the sensing procedure is power intensive, mechanisms are needed at the MAC layer to minimize these LBT failures.

A third issue that needs to be solved relates to the impact of unlicensed spectrum operation on the Sidelink HARQ feedback design.

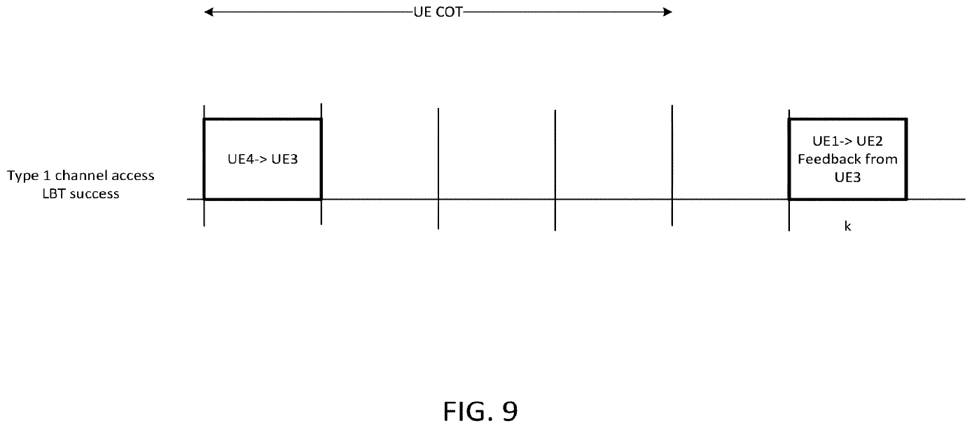

The feedback for sidelink transmissions are transmitted over the PSFCH channel. The timing of the transmissions is fixed to a certain number of slots from the PSSCH reception. The PSFCH occurs in a few symbols at the end of a slot. However, the slot is not typically used by the same UE that is transmitting the feedback. So as shown in FIG. 9, slot k is used for sidelink transmissions from UE1 to UE2, as well as feedback transmissions from UE3 to UE4. In this case, the feedback transmission from UE3 goes in the PSFCH that is in a slot for SL transmission from UE1 to UE2. It is assumed that LBT for this slot may be done by UE1, and as a result, UE3 does not know if the slot is actually acquired for the SL transmission. This poses a problem in unlicensed bands, as the CCA is done by UE1. It is not clear how UE3 would know that UE1 has acquired the channel (had an LBT success) or not acquired the channel (had an LBT failure). How UE3 behaves may depend on whether it knows if UE1 acquired the channel or not. Furthermore, in the case of an LBT failure, the UE3 actions are not specified.

Lastly, as a result of LBT failures, a RX UE may not be able to transmit its feedback to the TX UE. In licensed systems, when a TX UE does not receive any feedback, the TX UE takes this as indication of a HARQ DTX, and performs a sidelink retransmission. The TX UE assumes that the lack of feedback is because the RX UE failed to receive the SCI scheduling the transmission. However, because of LBT, it is possible that a RX UE fails to acquire the channel, and as a result does not transmit the feedback (even if the feedback is an ACK). The TX UE may interpret this as a HARQ DTX and make an unnecessary sidelink retransmission—which may not be efficient.

A fourth issue to solve relates to the impact of unlicensed spectrum operation on the SL transmissions over TX Resource Pools.

Some regulatory domains have requirements related to occupied channel bandwidth. For example, the European Telecommunication Standardization Institute (ETSI) mandates that the occupied channel bandwidth, defined by 3GPP to be the bandwidth containing 99% of the power of the signal, shall be between 80% and 100% of the declared nominal channel bandwidth. Sidelink transmissions from a UE are restricted to the configured TX resource pools. The bandwidth of these pools are typically much smaller than nominal channel bandwidth. Meeting the occupied channel bandwidth requirement may be difficult as sidelink transmissions are over TX resource pools. A fifth issue to solve relates to the impact of unlicensed spectrum operation on the design of Channel Occupancy Time for Sidelink Transmissions.

For Uu, Channel Occupancy Time refers to the total time for which eNB/gNB/UE and any eNB/gNB/UE(s) sharing the channel occupancy perform transmission(s) on a channel after an eNB/gNB/UE performs the corresponding channel access procedures. For determining a Channel Occupancy Time, if a transmission gap is less than or equal to 25 μs, the gap duration is counted in the channel occupancy time. A channel occupancy time may be shared for transmission between an eNB/gNB and the corresponding UE(s).

However, the notion of a COT for sidelink is not clear. In particular, it is unclear how a UE would know that a slot is part of a shared COT.

Methods are proposed herein for resource allocation over unlicensed bands. In particular, the following methods are: 1) Procedures to resolve the issues resulting from sidelink transmissions over a TX resource pool which has gaps both in frequency domain and in time domain. 2) Procedure for determining whether a slot is part of a shared COT. 3) Procedures for transmitting HARQ feedback over PSFCH over unlicensed bands. 4) Procedures for Resource Allocation Mode 1 for in-coverage UEs with Uu over Licensed Spectrum and PC5 over Unlicensed Spectrum. 5) Procedures for Resource Allocation Mode 1 for in-coverage UEs with Uu over Unlicensed Spectrum and PC5 over Unlicensed Spectrum. 6) Procedure for Resource Allocation Mode 2 for out-of-coverage UEs with PC5 over Unlicensed Spectrum, where the LBT sensing is done before the resource (re)selection sensing. 7) Procedure for Resource Allocation Mode 2 for out-of-coverage UEs with PC5 over Unlicensed Spectrum, where the resource (re)selection sensing is done before the LBT sensing. The following ideas are discussed herein:

1) A UE with traffic to send over sidelink resources where the sidelink resources are over unlicensed spectrum, and wherein the UE: Determines whether the UE is in-coverage or out-of-coverage. Determines transmit opportunities for the sidelink transmissions, based in part on the in-coverage and out-of-coverage determination. Makes a sidelink transmission over a slot k, if LBT is successful.

2) The UE of idea 1, wherein the UE further determines if slot k is part of a shared COT.

3) The UE of idea 2, wherein the UE further maintains COT sharing information for each shared COT.

4) The UE of idea 2, where the COT sharing information includes one or more of the following: Whether shared COT is UE initiated or gNB initiated, the UE identity of the UE that initiated the COT, the start time of the shared COT, the end time of the shared COT, the time remaining in the shared COT.

5) The UE of idea 2, wherein the determination of whether a slot is part of a shared COT is based on UE initiating it's on COT and storing the COT sharing information.

6) The UE of idea 2, wherein the determination of whether a slot is part of a shared COT is based on information received in SL grant from gNB.

7) The UE of idea 2, wherein the determination of whether a slot is part of a shared COT is based on information received in SCI of peer UE transmissions.

8) The UE of idea 1, wherein the UE may request that a gNB initiate a shared COT or a periodic shared COT.

9) The UE of idea 8, wherein the request is carried in an RRC message, a MAC CE, or a PHY DCI.

10) The UE of idea 2, wherein the UE further determines if a PSFCH transmit opportunity is part of a shared COT.

11) The UE of idea 10, wherein the UE transmits the HARQ feedback using Type 2C channel access procedure if the PSFCH opportunity is part of a shared COT

12) The UE of idea 10, wherein the UE transmits the HARQ feedback using Type 1 channel access procedure if the PSFCH opportunity is no part of a shared COT

13) The UE if idea 1, wherein the UE is configured to send HARQ feedback only after receiving a configured number of retransmissions of a transport block

14) The UE if idea 13, wherein the transmissions and retransmissions of a transport block are consecutive (in a burst)

15) The UE of idea 14, where the UE determines the PSFCH to use for the HARQ feedback based on the first received transport block of the burst.

16) The UE of idea 14, where the UE determines the PSFCH to use for the HARQ feedback based on the last received transport block of the burst.

17) The UE of idea 1 wherein as part of determining the transmit opportunities, the UE uses resource allocation mode 1, and UE may receive Grant Assistance information in the received sidelink grant.

18) The UE of idea 17, wherein the Grant Assistance information may include one or more of the following: whether UE may transmit outside the TX resource pool to meet the channel occupation requirements, indication of LBT sensing to use per SL grant, indication if assigned grant is part of a shared COT, indication if UE may monitor SL transmissions to determine if grant is part of a shared COT, COT sharing information.

19) The UE of idea 1, wherein as part of determining the transmit opportunities, the UE uses resource allocation mode 2, and wherein the UE performs resource (re)selection sensing first, followed by LBT sensing.

20) The UE of idea 19, wherein the sensing window size is increased to account for channel being acquired by other terminals.

21) The UE of idea 19, wherein the sensing window is non-contiguous and includes only periods during which the channel is acquired for 3GPP operation.

22) The UE of idea 19, wherein the MAC layer of the UE provides COT sharing information to the PHY layer.

23) The UE of idea 19, wherein the PHY layer determines a state for each slot in the sensing window, the state being from one of the following: not configured for SL transmission, free, acquired by non-NR system, acquired by NR system but slot has no SL transmission, acquired by NR system and slots has a SL transmission.

24) The UE of idea 19, wherein the candidate resource set provided by the PHY layer excludes slots acquired by non-NR systems, or slots that are free but outside of a shared COT.

25) The UE of idea 19, where the MAC layer tries to schedule initial transmission and retransmission within the shared COT.

26) The UE of idea 19, where if the initial transmission results in an LBT failure, the UE attempts to send the initial transmission in one of the reserved resources.

27) The UE of idea 19, wherein the 1st stage SCI is included in one or more of the reserved resources for the retransmissions.

28) The UE of idea 1, wherein as part of determining the transmit opportunities, the UE uses resource allocation mode 2, and wherein the UE performs LBT sensing first, followed by resource (re)selection.

29) The UE of idea 1, where the SL transmission is over a TX resource pool, and wherein the UE sends dummy data outside the TX resource pools in slot k.

30) The UE of idea 29, where the UE is configured with a set of resource blocks to use for dummy data transmission.

31) The UE of idea 1, wherein the UE signals capability to send dummy data to assist in COT sharing.

In the following, the terms band and spectrum are used interchangeably. Furthermore, the solutions described in the detailed description refer to operation over unlicensed bands or spectrum. The same solutions may be applicable to any shared spectrum where coexistence relies on a listen-before-talk like mechanism.

In the following, it is proposed that the UEs be configured with the necessary parameters to operate over the unlicensed band. The configuration may be provided through preconfiguration, configuration through system information, configuration through dedicated signaling from a serving base station or from a peer UE, or pre-provisioned.

An LBT failure may be understood as a transmission attempt over unlicensed spectrum that results in a failure. The transmission is unavailable as the channel is being used by another user. The other user may be from the same system or different system, using the same technology or different technology. An LBT failure applies to a given transmission.

An LBT success may be understood as a transmission attempt over unlicensed spectrum that results in a success. The transmitter has sensed the channel and determined that no other user is using the channel. The other user may be from the same system or different system, using the same technology or different technology. An LBT success applies to a given transmission.

An LBT attempt may be understood as a transmission attempt to access a channel. The result of an LBT attempt is either an LBT success or LBT failure. An LBT attempt applies to a given transmission.

An LBT state may be understood as the monitored state of the channel that is to be used for transmission, A channel may be in at least 2 states: busy or free. When the LBT state of a channel is “busy”, transmission attempts may result in LBT failures. When the LBT state of a channel is “free”, transmission attempts may result in LBT successes. The LBT state may be continually available to the MAC layer.

The terms node and terminal may be used interchangeably. A UE may be a special type of node that supports 5G NR.

Two types of Sensing may be contemplated: 1) Resource (re)selection sensing: this sensing is done to find resources in the future. So UE reads the SCI and knows about future reservations (these are for retransmissions as well as new transmissions). Sensing is only in resource pool. The UE continually does this type of sensing. 2) LBT sensing: this sensing is done to see if channel is free. It is not specified when this is done, but it is needed when the UE has to perform a transmission. When a UE does LBT sensing, it would determine whether a channel is being used by another terminal. LBT sensing not based on transmission slots, but rather “sensing slots”.

Licensed spectrum is spectrum that is used exclusively by one organization for all its terminals.

Unlicensed spectrum is spectrum that is not exclusively owned by any organization, but may be shared between terminals of different organizations. The use of the spectrum is determined by regulatory requirements, and often has limits with regards to how to share the spectrum in a friendly manner.

Reserved spectrum is spectrum that is reserved for a specific purpose and only terminals of a certain type may use this spectrum. Typical examples include the Intelligent Transportation Systems (ITS) spectrum, which is reserved for vehicular communications, and only used by ITS terminals. Hereinafter, the design of resource pools for unlicensed bands is discussed.

The resource allocation for sidelink transmissions may depend on three main factors: whether the UE is in-coverage or out-of-coverage, whether the Uu interface uses licensed or unlicensed spectrum, whether the PC5 interface uses licensed, unlicensed, or reserved spectrum, and whether the resource allocation mode is mode 1 or mode 2. This results in a list of fifteen combinations (as shown in Table 4). Combinations 1, 2, 3, 4, 13, 14 are already supported in Rel15 and Rel16 sidelink.

TABLE 4
Resource Allocation Combinations

| | IC vs | Uu | PC5 | Resource Allocation |
|---|---|---|---|---|
| Combination | OOC | interface | Interface | Mode |
| 1 | IC | Licensed | Licensed | Mode 1 |
| 2 | IC | Licensed | Licensed | Mode 2 |
| 3 | IC | Licensed | Reserved | Mode 1 |
| 4 | IC | Licensed | Reserved | Mode 2 |
| 5 | IC | Licensed | Unlicensed | Mode 1 |
| 6 | IC | Licensed | Unlicensed | Mode 2 |
| 7 | IC | Unlicensed | Licensed | Mode 1 |
| 8 | IC | Unlicensed | Licensed | Mode 2 |
| 9 | IC | Unlicensed | Unlicensed | Mode 1 |
| 10 | IC | Unlicensed | Unlicensed | Mode 2 |
| 11 | IC | Unlicensed | Reserved | Mode 1 |
| 12 | IC | Unlicensed | Reserved | Mode 2 |
| 13 | OOC | NA | Licensed | Mode 2 |
| 14 | OOC | NA | Reserved | Mode 2 |
| 15 | OOC | NA | Unlicensed | Mode 2 |

The SL BWP has different lists of resource pools for transmissions and receptions, to allow for a UE to transmit in a pool and receive in another one. For transmissions, there is at least one pool for UE selected mode, at least one pool for scheduled mode (e.g., when the gNB helps with resource selection), and at least one pool for exceptional situations. Resource pools are expected to be used for only transmission or reception, except when the feedback mechanisms are activated, in which case a UE would transmit Acknowledgement (ACK) messages in a reception pool and receive ACK messages in a transmission pool.

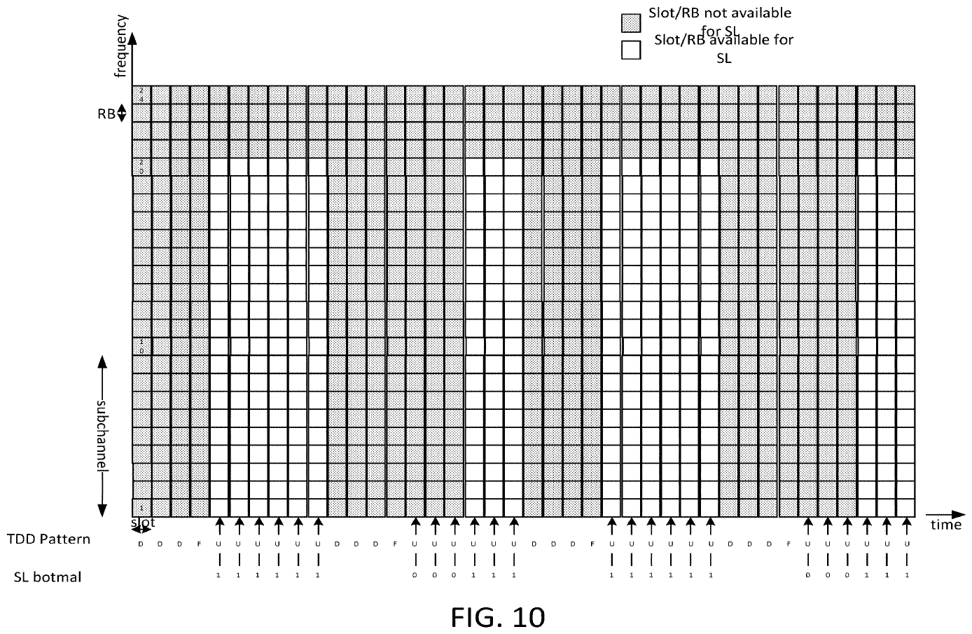

As shown in FIG. 10, a resource pool located inside an SL BWP may be defined by a set of sl-Rb-Number contiguous Resource Blocks (RBs) in the frequency domain starting at RB sl-StartRBsubchannel. The resource pool is further divided into subchannels of size sl-SubchannelSize, which may take one of several values (i.e., 10, 12, 15, 20, 25, 50, 75, and 100). The notion of a subchannel is essential for the sensing mechanisms designed by 3GPP. Depending on the value of sl-RB-Number and sl-SubchannelSize, some RBs inside the resource pool may not be used by the UEs. As such, some consistency is needed in order to avoid wasting resources.

In the time domain, a resource pool has some available slots configured by various parameters. To determine which slots belong to the pool, a series of criteria are applied: 1) Slots where SSB is transmitted may not be used. The number and locations of those slots are based on configuration. 2) Slots that are not allocated for UL (e.g., in the case of Time Division Multiplexing (TDD)) or do not have all the symbols available (as per SL BWP configuration) are also excluded from the resource pool. 3) Some slots are reserved such that the number of remaining slots is a multiple of the sl-TimeResource-r16 bitmap length (also defined as Lbitmap), that may range from 10 bits to 160 bits. The reserved slots are spread throughout 10240*2\hat{ }μ slots, where μ is the numerology. 4) The bitmap sl-TimeResource-r16 is applied to the remaining slots to compute the final set of slots that belong to the pool, and which repeats every 10240*2\hat{ }μ slots.

Sidelink transmissions from a TX UE may occur in resource pools (which do not occupy the entire band), and SL transmissions from a UE are not necessarily contiguous. In some cases, certain slots are not allowed as sidelink transmission slots. As a result, gaps in the frequency domain and in the time domain may occur.

The resource pools may not occupy the full operating bandwidth. When a UE gets a channel, the UE transmits in the configured TX resource pool. The UE may not be able to spread transmissions across the operating bandwidth. In order to meet the channel occupation requirements, one or more of the following alternatives may be used: In a first alternative, a UE that makes a SL transmission in slot k, may send dummy data in frequency bands outside the TX resource pools in the slot k. The dummy data may tell the other nodes that the channel is busy. The UE may be (pre)configured with a set of resource blocks that are outside the TX resource pools, and that are set aside for this purpose. In another option to this alternative, the UE could ask another peer UE to transmit data in slot k, in the areas outside the TX resource pool.

In a second alternative, a UE that acquires the channel and starts a COT, may send dummy data in frequency bands outside the TX resource pools in all slots of the COT. The dummy data may tell the other nodes that the channel is busy. The UE may be (pre)configured with a set of resource blocks that are outside the TX resource pools, and that are set aside for this purpose. In another option to this alternative, the UE could ask another peer UE to transmit in all slots of the COT, in the areas outside the TX resource pool.

In a third alternative, if the UE is in coverage, the gNB may know when the sidelink transmissions are scheduled (for example the UE is using Mode 1 resource allocation). If the gNB knows that a UE will transmit in slot k, the gNB may transmit in the slot k in the areas outside the TX resource pool. In another further option to this alternative, the gNB could ask another peer UE to transmit in this area.

In a fourth alternative, the 5G system may designate certain TX resource pools as a minimum set of TX resource pools to guarantee compliance with the channel occupation requirements. Furthermore, one UE may be configured as a designated UE for each of these TX resource pools. If a UE gains access to the channel, it may request that the designated UE in each TX resource pool that is part of the minimum set TX resource pools, transmit over the SL.

As shown in FIG. 10, the resource pools may not allow transmission in all slots. When a COT is shared for SL transmissions, certain slots may not be used for SL transmissions. If a number of these slots are adjacent, another terminal from a non-NR system may access the channel. Thereby the NR system may lose access to the channel and the shared COT. In order to retain access to the shared COT, one or more of the following alternatives are proposed.

In a first alternative, the gNB may restrict the sl-DCI-ToSL-Trans to a range to guarantee that the COT obtained by the gNB may be used by the UE for the first scheduled SL transmission. The DCI scheduling the SL transmissions may also include an indication of the channel access type to be used by the UE.

In a second alternative, the gNB may schedule the sidelink transmissions, but also indicate that the UE is to monitor a channel reservation signal (CRS). The UE would monitor this signal. When found, the sidelink grant may be relative to the slot on which this signal is received.

In a third alternative, when the gNB knows of slots in the resource pool that are not allowed for SL transmissions, the gNB may schedule uplink transmissions from other UEs in order to maintain the acquired channel. The gNB may favor scheduling UL transmissions in these slots, or it may schedule dummy transmissions from UEs in these slots. Or it may send DL data in these slots, or it may send dummy data in these slots, or it may send control plane signaling in these slots, or it may send PHY layer signaling in these slots. The UEs may have a capability to support transmission of dummy data. This capability may be exchanged as part of the UE registration process. Alternatively, the UE may signal to the gNB whether it wants to participate in this procedure.

In a fourth alternative, gNB may configure all slots in a TX resource pool to allow sidelink transmissions.

In a fifth alternative, the gNB may configure multiple adjacent slots in a resource pool with gaps only between the set of adjacent slots. The gNB may also guarantee that the gaps are less than a certain value, in order to guarantee that no Non-NR terminal gains access to the channel.

In a sixth alternative, UEs transmit dummy data in these slots to keep the channel. The UEs may transmit this dummy data always, or when there is a SL grant, or when the UEs are scheduled by the gNB. That is, the gNB may schedule transmissions in these slots to keep them occupied. Hereinafter, procedures for determining whether a slot is part of a shared COT are discussed.

The gNB may dynamically assign SL grants (mode 1 dynamic grant), or these may be configured by RRC (mode 1 configured grant), or these may be determined autonomously by the UEs (mode 2 grant). In each of these cases, the UE may need to know if the grant is to be used in a slot that is part of a shared COT. Different rules may apply for grants that are part of a shared COT and for grants that are not part of a shared COT.

As part of the shared COT determination mechanism, the UE may store information related to the shared COT (as part of COT sharing information). The COT sharing information may include one or more of the following: 1) if the shared COT was determined from a DCI received over the Uu interface, 2) if the shared COT was determined from an SCI received over the SCI interface, 3) if the shared COT is UE initiated, 4) if the shared COT is gNB initiated, 5) if UE initiated, the UE identity of the UE that initiated the COT, 6) the start time of the shared COT, 7) the end time of the shared COT, 8) the time remaining in the shared COT, 9) the duration of the shared COT (from the start time), 10) any restrictions related to the shared COT. For example, shared COTs may be restricted to certain: cast types, UE identities, services, destination Layer 2 IDs, Source Layer 2 IDs, QoS profiles, traffic priority, etc.

A UE may determine that a slot is part of a shared COT by one or more of the following mechanisms:

Shared COT determination mechanism 1: A UE may initiate a COT by acquiring the channel through a Type 1 channel access procedure. Once acquired, the UE knows the slots that are part of a shared COT. The UE also knows the duration of the shared COT, or the time at which the shared COT ends. The UE may determine the other COT sharing information.

Shared COT determination mechanism 2: a gNB may provide an indication with the SL grant that the grant is scheduled on a slot that is part of a shared COT. The gNB may further provide an indication about the time at which the shared COT ends as well as other COT sharing information. This information may be provided as part of the DCI that includes the SL grant.

Shared COT determination mechanism 3: when a UE acquires a channel and starts a shared COT, the UE transmits the information as part of the SCI, either as part of the first stage SCI or as part of the 2^{nd} stage SCI. The information may include the duration of the shared COT, or the time at which the shared COT ends as well as other COT sharing information. Other UEs, upon receiving the SCI, may know that a shared COT has started. These other UEs may also determine the identity of the UE that initiated the shared COT.

Shared COT determination mechanism 4: a gNB may provide an indication with certain SL grants that these grants are part of a shared COT. The gNB may further provide an indication about the time at which the shared COT ends. The information may be provided as part of the DCI that includes the SL grant. The information may be provided for the first K SL grants of a shared COT. The UEs receiving these SL grants may include the shared COT information in their SL transmissions, as part of the SCI, either in the first stage SCI or in the 2^{nd} stage SCI. The information may include the duration of the shared COT, or the time at which the shared COT ends, and an indication that this shared COT was initiated by the gNB. Other UEs, upon receiving the SCI, may know that a shared COT has started. These other UEs may also determine that the shared COT was initiated by a gNB.

Shared COT determination mechanism 5: a gNB may provide an indication of the shared COT through signaling to a particular UE (for example through dedicated signaling), a group of UEs (for example through some multicast mechanism), or to all UEs (for example through a broadcast mechanism such as system information). This indication may tell the UEs that the channel is reserved for one or more of the following: 1) reserved and may be used for sidelink transmission, 2) reserved and may not be used for sidelink transmission, 3) reserved for a particular SL unicast transmission or set of SL unicast transmissions, 4) reserved for a SL groupcast transmission or set of SL groupcast transmissions, 5) reserved for SL broadcast transmissions, 6) reserved for a particular UE or group of UEs. Note that a shared COT may be initiated by both the gNB and the UEs after a Type 1 channel access procedure. In some cases, for transmission of the Discovery Reference Signals, the gNB may also initiate a shared COT after a Type 2 channel access procedure. In addition, a gNB may trigger a periodic shared COT. The gNB may regularly start a shared COT so that the NR system has regularly occurring periods where it has acquired the channel. These periods may be useful for certain NR procedures, for example the Resource (re)selection sensing procedure. In addition, a UE may request that a gNB start a shared COT or a periodic shared COT. This request may be carried in an RRC message, a MAC CE, or a PHY DCI.

Hereinafter, procedures for transmitting HARQ feedback over PSFCH over unlicensed bands, are discussed.

In NR V2X, the primary purpose of PSFCH is to carry the HARQ feedback from RX UE(s) to a TX UE. Within a resource pool, resources for PSFCH may be (pre-)configured periodically with a period of 1, 2 or 4 slot(s), i.e., there is a slot with PSFCH every 1, 2 or 4 slot(s) within a resource pool. PSFCH is sent in one symbol among the last SL symbols in a PSCCH/PSSCH slots. In NR Uu, the PDSCH-to-HARQ timing (similar to the K slots for the SL HARQ feedback) is signaled in the DCI for each DL transmission. In NR V2X, the PSSCH-to-HARQ feedback timing is not indicated in the SL control information, as it is (pre-)configured per resource pool with the parameter sl-MinTimeGapPSFCH, sl-MinTimeGapPSFCH is the minimum time gap between PSFCH and the associated PSSCH in the unit of slots, and may take on the values of 2 or 3 slots.

The PSFCH is transmitted by a sidelink receiving UE for unicast and groupcast, which conveys 1 bit information over 1 RB for the HARQ acknowledgement (ACK) and the negative ACK (NACK). At every one, two, or four slots, the last two symbols excluding the guard period (GP) symbol are able to accommodate the PSFCH. Given a certain time-frequency location of the PSSCH, to identify the “actual” time-frequency location (resources) of the corresponding PSFCH, the candidate resources of the corresponding PSFCH may be identified first. For a PSSCH transmission, the candidate resources of the corresponding PSFCH is the set of RBs associated to the starting subchannel and slot used for that PSSCH. With L sub-channels in a resource pool and N PSSCH slots associated with a slot containing PSFCH, there are (N)(L) sub-channels associated with a PSFCH symbol. With M PRBs available for PSFCH in a PSFCH symbol, there are M PRBs available for the HARQ feedback of transmissions over (N)(L) sub-channels. The frequency resources for the actual PSFCH transmission are indicated by a bitmap for RBs in a resource pool. With M configured to be a multiple of (N)(L) a distinct set of Mset=M/(NL) PRBs may be associated with the HARQ feedback for each sub-channel within a PSFCH period. The first set of Mset PRBs among the M PRBs available for PSFCH are associated with the HARQ feedback of a transmission in the first sub-channel in the first slot. The second set of M set PRBs are associated with the HARQ feedback of a transmission in the first sub-channel in the second slot and so on.

Since the PSFCH transmission is from a RX UE, there is no associated SL grant for its transmission. In fact, the slot carrying the PSFCH may be for SL transmissions between a different set of peer UEs. As a result, the RX UE may not know if the slot carrying the PSFCH falls inside a shared COT or not. The RX UE may use information available to it make this decision. Possible rules may include:

Rule 1: the RX UE determines if the PSFCH falls in a shared COT. The UE may maintain information regarding the state of the channel, that is whether the channel is currently being used as part of a shared COT. The UE may determine the duration of a shared COT, or end time of a shared COT based on one of the Shared COT determination mechanisms. If the RX UE determines that the PSFCH falls inside a shared COT, the UE may transmit the HARQ feedback using Type 2C channel access procedure. If the RX UE determines that the PSFCH does not fall inside a shared COT, the UE may transmit the HARQ feedback using Type 1 channel access procedure. The RX UE may be (pre)configured with information regarding whether RX UE needs to transmit in the slot containing the PSFCH symbol in order to prevent other terminals from gaining access to the channel. The RX UE may make these transmissions in dedicated subchannels of each resource pool, in dedicated resource pools, etc.

Rule 2: When the RX UE receives the PSCCH and subsequent PSSCH, the TX UE may signal that the PSFCH is part of a shared COT. It may also signal to the RX UE that it needs to transmit in the slot containing the PSFCH symbol in order to prevent other terminals from gaining access to the channel. The RX UE may make these transmissions in dedicated subchannels of each resource pool, in dedicated resource pools, etc.

Rule 3: as part of the SL grant from the gNB that schedules the initial transmission and potentially one or more retransmissions, the gNB also provides a feedback grant for the HARQ feedback from the RX UE. This feedback grant is provided to the RX UE through the SCI that schedules the transmissions and retransmissions. This feedback grant may also include an indication of it falls within the shared COT of the gNB as well as an indication of which channel access procedure to use for the feedback transmission. If the RX UE has no data to send with this grant, it may send dummy data (either broadcast, groupcast, or unicast).

In another enhancement, the RX UE may be configured to send HARQ feedback only after receiving all retransmissions of a transport block. In unlicensed spectrum, the gNB may schedule the initial transmission and retransmissions as a burst (for example in consecutive slots). In such a case, the RX UE may transmit only a single HARQ feedback, after reception of a configured number of transmissions of a transport block. In such a case, the RX UE may need to know which PSFCH to associate with the burst transmission of the transport block. The RX UE may decide to use the PSFCH associated with the first received transport block of the burst. Alternatively, the RX UE may decide to use the PSFCH associated with the last received transport block of the burst.

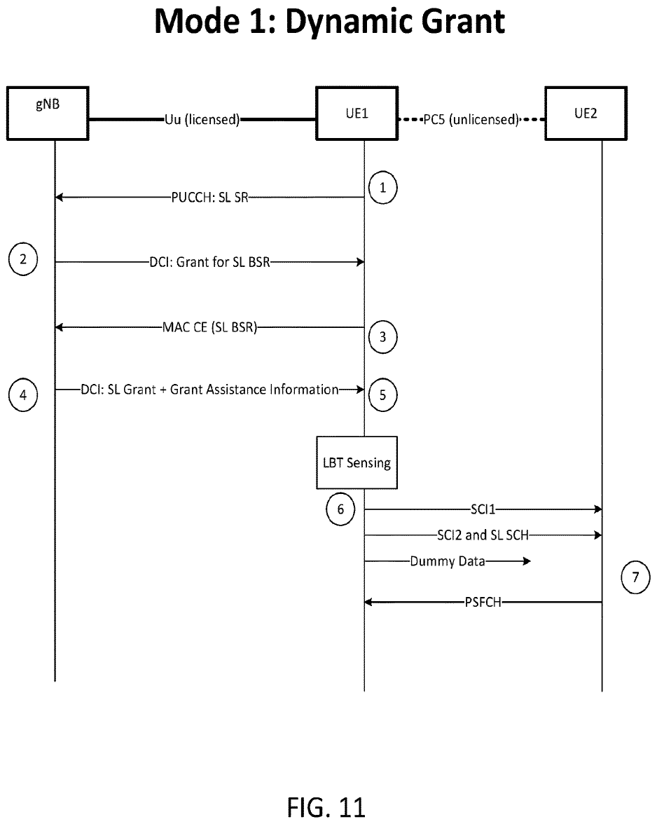

The following steps of a call flow for resource allocation mode 1 for in-coverage UEs with Uu over Licensed Spectrum and PC5 over Unlicensed Spectrum are shown in FIG. 11.

Step 1: The UE may send a sidelink Scheduling Request. The Scheduling Request (SR) may be used for requesting SL-SCH resources for new transmission when triggered by the Sidelink BSR. The SL SR is sent over licensed spectrum.

Step 2: The gNB may assign a grant for transmission of the SL BSR.

Step 3: The UE may send the SL BSR to the gNB.

Step 4: The gNB may assign SL resources to the UE. As part of this step, the gNB may provide grant assistance information to the UE. This grant assistance information may be provided in the grant message, for example included in the DCI carrying the SL grant. The grant assistance information may include one or more of the following:

Grant Assistance information 1: COT sharing information.

Grant Assistance information 2: indication whether UE may transmit outside resource pool to reserve the channel. The gNB could also provide an indication as to what the UE may transmit outside the TX resource pool. This may be dummy data, reference signals, etc.

Grant Assistance information 3: indication if the gNB may transmit outside the TX resource pools to help reserve the channel.

Grant Assistance information 4: indication if another UE may transmit outside the TX resource pools to help reserve the channel.

Grant Assistance information 5: indication whether the assigned grant may be used without LBT sensing.

Grant Assistance information 6: indication whether the assigned grant requires LBT sensing. If yes, the gNB may also provide an indication of the type of LBT sensing. For example, this may be in terms of the type of channel access procedure UE is to perform for the transmission. This may be from: Type 1 SL channel access procedure, Type 2A SL channel access procedure, Type 2B SL channel access procedure, Type 2C SL channel access procedure. Additionally, this may be from a union of 2 or more channel access procedures. For example a SL grant may indicate Type 1 OR Type 2B channel access procedure. In such cases with multiple indicated channel access procedures, the UE may have rules for selecting one procedure over another. In a typical example, the UE may receive multiple SL grants (for an initial transmission and up to 2 retransmissions). One of these grants may be indicated as Type 1 or Type 2B. If the grant is used during a COT, the UE may rely on the Type 2B channel access procedure. Otherwise, the UE may default to Type 1 channel access procedure.

Grant Assistance information 7: indication whether the assigned grant is in a shared COT. The shared COT may have been started by another UE that acquired the channel in a prior transmission.

Grant Assistance information 8: indication whether the UE may check for other SL transmissions to determine if the grant is in a shared COT.

Step 5: The UE receives the grant. If indicated that the grant does not require LBT sensing, the UE transmits on the sidelink over the assigned grant. If the indicated grant requires LBT sensing, the UE performs LBT sensing prior to the transmission opportunity, using the channel access procedure indicated in the grant. If the UE gains access to the channel, the UE continues with its SL transmission.

Step 6: The UE may need to transmit outside the TX resource pools, if indicated in the grant assistance information.

Step 7: The SL transmission is received by the RX UE. The RX UE may be configured to respond with HARQ feedback. The RX UE may follow one or more procedures for transmitting HARQ feedback over PSFCH over unlicensed bands. For example, the method described in FIG. 11 may comprise receiving, at a user equipment (UE) and from a gNodeB (gNB), grant assistance information for sidelink (SL) transmission, wherein the grant assistance information comprises at least one of: an indication for the UE to transmit outside a transmission (TX) resource pool to meet the channel occupation requirements, an indication of listen before talk (LBT) sensing to use per SL grant, an indication if the assigned grant is part of a shared channel occupancy time (COT), an indication for the UE to monitor SL transmissions to determine if a grant is part of a shared COT, or COT sharing information. The method may further comprise determining, based on the received grant assistance information, at least one transmit opportunity for sidelink transmission. The method may further comprise performing, based on the received grant assistance information, LBT sensing. The method may further comprise sending, based on determining the LBT sensing is successful, a sidelink transmission over the determined transmit opportunity, wherein the sidelink transmission comprises shared COT information.

The method described in FIG. 11 may further comprise determining, by the UE, if slot k associated with a physical sidelink shared channel (PSSCH) is associated with a shared COT. The UE may determine if the slot k is associated with a shared COT based on information received in the grant assistance information. The UE may maintain the COT sharing information associated with each shared COT of one or more shared COTs. The COT sharing information comprises at least one of whether a shared COT is initiated by a UE or initiated by a gNB, the identity of a UE that initiated a shared COT, a start time of a shared COT, and end time of a shared COT, or a time remaining in a shared COT. The UE may further determine if a physical sidelink feedback channel (PSFCH) comprises a shared COT. The UE may increase a size of a sensing window based on the sidelink channel being acquired by at least one other UE. A PHY layer determines a state for each slot in the sensing window, wherein the state for each slot comprises at least one of not configured for SL transmission, free, acquired by a non-new radio (NR) system, acquired by an NR system but the slot is not hosting a SL transmission, or acquired by an NR system and the slot is hosting a SL transmission. The UE may determine one or more reserved resources and wherein the LBT sensing fails the ULE may send, based on the LBT sensing failure, the sidelink transmission via at least one of the one or more reserved resources. Furthermore, the sidelink transmission over the determined transmit opportunity may comprise dummy data.

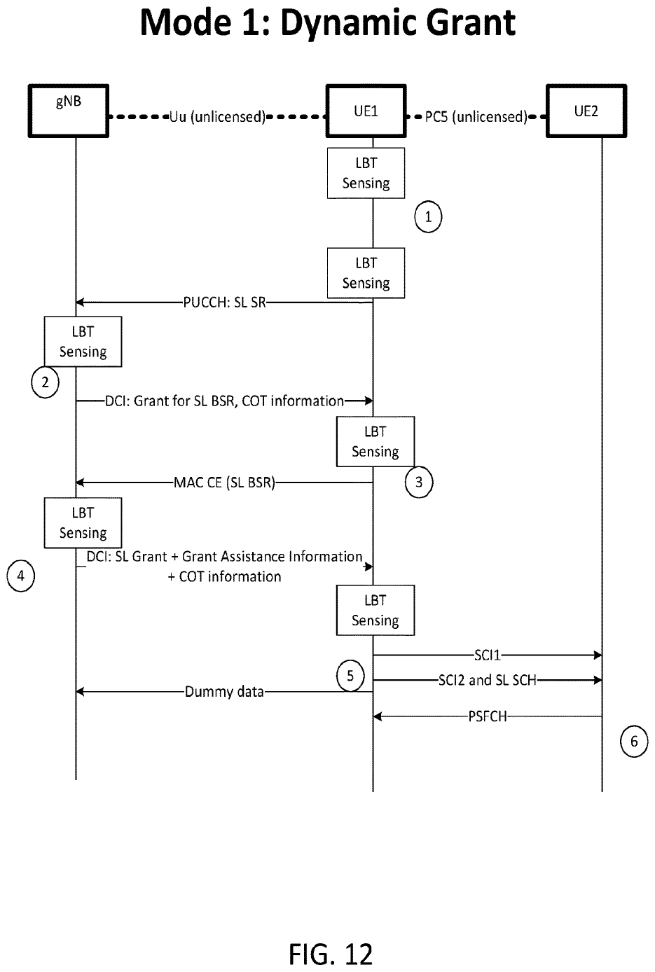

The following steps of a call flow for resource allocation mode 1 for in-coverage UEs with Uu over Unlicensed Spectrum and PC5 over Unlicensed Spectrum are shown in FIG. 12.

Step 1: The UE needs to send a sidelink BSR to the gNB. UE is triggered to send a sidelink Scheduling Request in the SR transmission occasion. The UE performs LBT for transmission of the SL scheduling request. If LBT is successful, the SL scheduling request is sent to the gNB, and the UE starts the sr-ProhibitTimer and increments the SR COUNTER. If LBT fails, the UE does not send the SL scheduling request, and waits for the next SR transmission occasion.

Step 2: The gNB assigns an UL grant for transmission of the SL BSR. The gNB may perform LBT before transmission of this grant. The transmission may initiate a COT for transmission of the UL grant. The UL grant may include an indication of the channel access procedure to use for the uplink transmission.

Step 3: The UE sends the SL BSR to the gNB in the gNB shared COT, following the channel access procedure indicated in the UL grant.

Step 4: The gNB assigns SL resources to the UE. As part of this step, the gNB may provide grant assistance information to the UE. This grant assistance information may be provided in the grant message, for example included in the DCI carrying the SL grant. The grant assistance information may include one or more of the following:

Grant Assistance information 1: COT sharing information.

Grant Assistance information 2: indication whether UE may transmit outside resource pool to reserve the channel. The gNB could also provide an indication as to what the UE may transmit outside the TX resource pool. This may be dummy data, reference signals, etc.

Grant Assistance information 3: indication if the gNB may transmit outside the TX resource pools to help reserve the channel.

Grant Assistance information 4: indication if another UE may transmit outside the TX resource pools to help reserve the channel.

Grant Assistance information 5: indication whether the assigned grant may be used without LBT sensing.

Grant Assistance information 6: indication whether the assigned grant requires LBT sensing. If yes, the gNB may also provide an indication of the type of LBT sensing. For example, this may be in terms of the type of channel access procedure UE is to perform for the transmission. This may be from: Type 1 SL channel access procedure, Type 2A SL channel access procedure, Type 2B SL channel access procedure, Type 2C SL channel access procedure. Additionally, this may be from a union of 2 or more channel access procedures. For example a SL grant may indicate Type 1 OR Type 2B channel access procedure. In such cases with multiple indicated channel access procedures, the UE may have rules for selecting one procedure over another. In a typical example, the UE may receive multiple SL grants (for an initial transmission and up to 2 retransmissions). One of these grants may be indicated as Type 1 or Type 2B. If the grant is used during a COT, the UE may rely on the Type 2B channel access procedure. Otherwise, the UE may default to Type 1 channel access procedure.

Grant Assistance information 7: indication whether the assigned grant is in a shared COT. The shared COT may have been initiated by another UE that acquired the channel in a prior transmission or it may have been initiated by the gNB.

Step 4: The UE receives the SL grant. If indicated that the grant does not require LBT sensing, the UE transmits on the sidelink over the assigned grant. If the indicated grant requires LBT sensing, the UE performs LBT sensing prior to the transmission opportunity, using the channel access procedure indicated in the grant. If the UE gains access to the channel, the UE continues with its SL transmission.

Step 5: During the SL transmission opportunity, the UE may need to transmit outside the TX resource pools, if indicated in the grant assistance information. Alternatively, during the SL transmission opportunity the gNB may transmit outside of the TX resource pools. The gNB may use this information to prioritize scheduling over these SL transmission opportunities, or the gNB may send dummy data over these SL transmission opportunities, or the gNB may send PHY layer signals over these SL transmission opportunities.

Step 6: The SL transmission may be received by the RX UE. The RX UE may be configured to respond with HARQ feedback. The RX UE may follow one or more procedures for transmitting HARQ feedback over PSFCH over unlicensed bands.

Note that both UEs in FIG. 12 may receive the shared COT information. How these UEs use this information depends on the configured resource allocation mode configured for these UEs.

Hereinafter, a procedure for Resource Allocation Mode 2 for out-of-coverage UEs with PC5 over Unlicensed Spectrum, is discussed

When a UE uses mode 2 resource allocation, the UE may need to make the resource (re)selection decisions based on Resource (re)selection sensing, which may determine a set of candidate resources in a selection window. From this candidate resource set, the UE may make resource (re)selection decisions to reserve resources for an initial transmission and 1 or 2 possible retransmissions of a transport block. For periodic services, the UE may further reserve resources (make resource selection decisions) for a number of future transmissions (for the initial transmission and 1 or 2 possible retransmissions). For the combination Resource Allocation Mode 2 for out-of-coverage UEs with PC5 over Unlicensed, the unlicensed band adds complexity in 1) the determination of the candidate resource set and 2) the need for LBT for transmission over the reserved resources.

There are two possible models for the resource (re)selection: Resource (Re)Selection Model 1: UE performs resource (re)selection sensing followed by LBT sensing. Resource (Re)Selection Model 2: UE performs LBT sensing (gets COT), and the UE performs resource (re)selection sensing. Note that although the procedures are described for out-of-coverage UEs, the procedures are also applicable to UEs in coverage, but which are configured to use resource allocation Mode 2 over unlicensed spectrum.

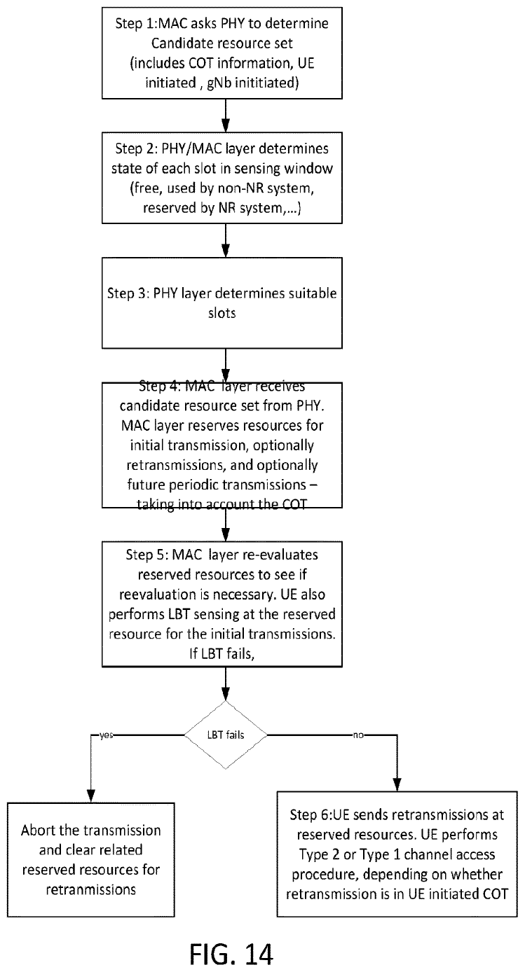

FIG. 14 describes a resource (re)selection model 1. The UE may perform resource (re)selection sensing first, obtain a candidate resource set, and reserve resources from the candidate resource set. The UE may perform LBT sensing before the reserved resource to determine if the channel is still free.

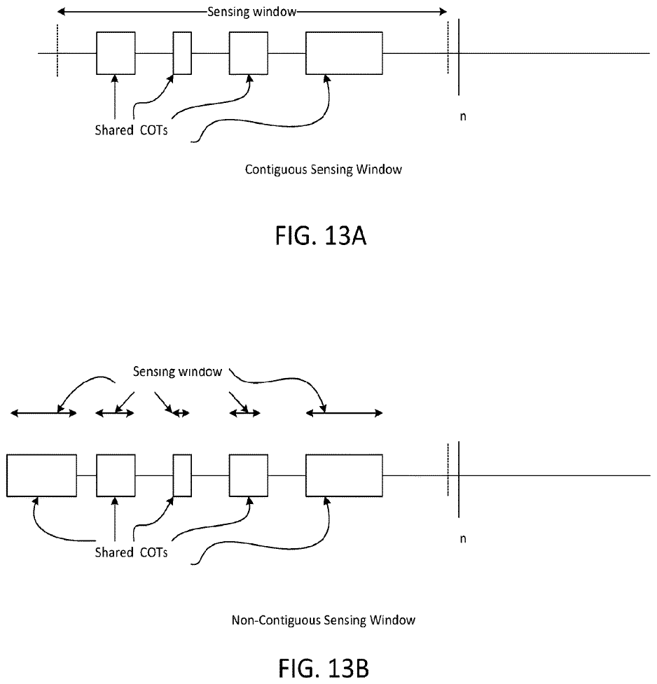

In a first step, when the UE has SL data to transmit, the UEs MAC layer may ask the PHY layer to determine the candidate resource set. The PHY layer maintains sensing results for the sensing window. For licensed spectrum, the sensing window may be either 1100 ms or 100 ms wide, with the intention that the 100 ms option is particularly useful for aperiodic traffic, and 1100 ms particularly for periodic traffic. Furthermore in licensed spectrum, this window is contiguous. For unlicensed spectrum, the window may be contiguous with a different size. The size may be larger than 1100 msec to take into account that the channel may be acquired by other terminals (terminals that are not UEs). Alternatively, the window size may be non-contiguous, only including periods during which the channel is acquired for 3GPP operation. The latter may be determined by periods that fall in shared COTs. A shared COT may be initiated by a gNB or it may be initiated by UEs. The UE may use the procedures for determining whether a slot is part of a shared COT, to determine the time periods that are reserved for 3GPP operation. The options are shown in FIG. 13A for the contiguous sensing window and in FIG. 13B for the non-contiguous sensing window.

For each of these, the MAC layer may provide the PHY layer an indication of the start time, stop time, and duration of each of the shared COTs. The MAC layer may also provide an indication of the shared COT is UE initiated or gNB initiated. Alternatively, the MAC layer may provide the COT sharing information to the PHY layer.

In a second step, the PHY/MAC layer may determine a state of each slot in the sensing window. The possible options for this state of the slot are: 1) Slot is not configured for SL transmission. UE may decide not to take measurements on these slots, 2) Slot is free: no other terminals using the channel and no SL transmissions, 3) Slot has been acquired by terminal from non-NR system, 4) Slot has been acquired by NR system (within a shared COT), but slot has no SL transmission, 5) Slot has been acquired by NR system (within a shared COT), and slot has SL transmission.

The UE may make measurements to make this state determination. For example, the UE may perform LBT sensing to determine if slot is free or used by a non-NR system. In addition, the UE may make SL-RSRP measurements on slots to determine the level of interference which would be caused and experienced if the UE were to transmit in these slots. In addition, the UE may rely on received SCI to determine if a slot has a SL transmission. As part of this determination, the UE may also be made aware if this transport block has any future reserved resources.

In a third step, the PHY layer may determine which of the resources are suitable to be included in the candidate resource set. The PHY layer may exclude all resources which it determines will be reserved. This may be determined from reading the SCI of the SL transmissions in the slots of the sensing window that are in a shared COT. The PHY layer may also exclude resources for which the SL-RSRP is above a threshold. The PHY layer may also exclude resources for which the slot is marked as acquired by a terminal from a non-NR system. The PHY layer may also exclude resources for which the slot is marked as free but which are outside of a shared COT.

In a fourth step, the PHY layer provides the candidate resource set to the MAC layer, which reserves resources from this candidate resource set (for an initial transmission and 2 or 3 retransmissions). The MAC layer may also reserve resources for future periodic transmissions from this UE. When reserving the resources for the initial transmission and the potential retransmissions, the MAC layer may guarantee that the reserved resources occur within the remaining packet delay budget of the transport block to be transmitted. It is further proposed that the MAC layer reserve resources so that the time interval to carry the initial transmission and its retransmissions is less than the maximum UE COT size or the maximum time remaining in the shared COT. This may improve the chances that the retransmissions results in LBT success. If not possible, one or more of the retransmissions may fall out of the UE initiated COT.

In a fifth step, a sensing UE may re-evaluate the set of resources from which it may select, to check whether its intended transmission is still suitable, taking account of late-arriving SCIs due, typically, to an aperiodic higher-priority service starting to transmit after the end of the original sensing window. If the reserved resources would not be part of the set for selection at time m-T3, new resources may be selected from the updated resource selection window. The cut-off time T3 is long enough before transmission to allow the UE to perform the calculations relating to resource re-selection. Between m-T3 and the transmission time, the UE may perform LBT sensing. If the LBT sensing fails, in a first alternative, the SL transmission is aborted and the UE selects new resources from the updated resource selection window. In addition all reserved resources related to the aborted SL transmission are cleared. If the LBT sensing fails, in a second alternative, the SL transmission is aborted and the UE tries to send the initial transmission on one of the other reserved resources. Note that the 1st-stage-SCI indicates the reservation of Nmax_reserve (preconfigured) number of sidelink resources within the selection window. Nmax_reserve may be 2 or 3. The resource reservation is indicated in the time resource assignment field of the 1st-stage-SCI. This means that not all the slots in a resource reservation period of a UE carry 1st-stage SCI in the PSCCH; some slots have empty PSCCH and only carry information in the PSSCH, as indicated by a 1st-stage-SCI in a previous slot. As a result, it is further proposed that the 1^{st} stage SCI may also be included in one or more of the reserved resources for the retransmissions. These 1^{st} stage SCIs may also indicate whether they are part of the 1^{st}, 2^{nd} or 3^{rd} retransmission. This latter information is used by the receiving UE to know how many more transmissions are expected.

In a sixth step, the UE sends the retransmissions on the reserved resource. If the retransmission falls within the UE initiated COT, the UE need only perform a Type 2 channel access procedure. If the retransmission falls outside of the UE initiated COT, the UE may need to perform a Type 1 channel access procedure.

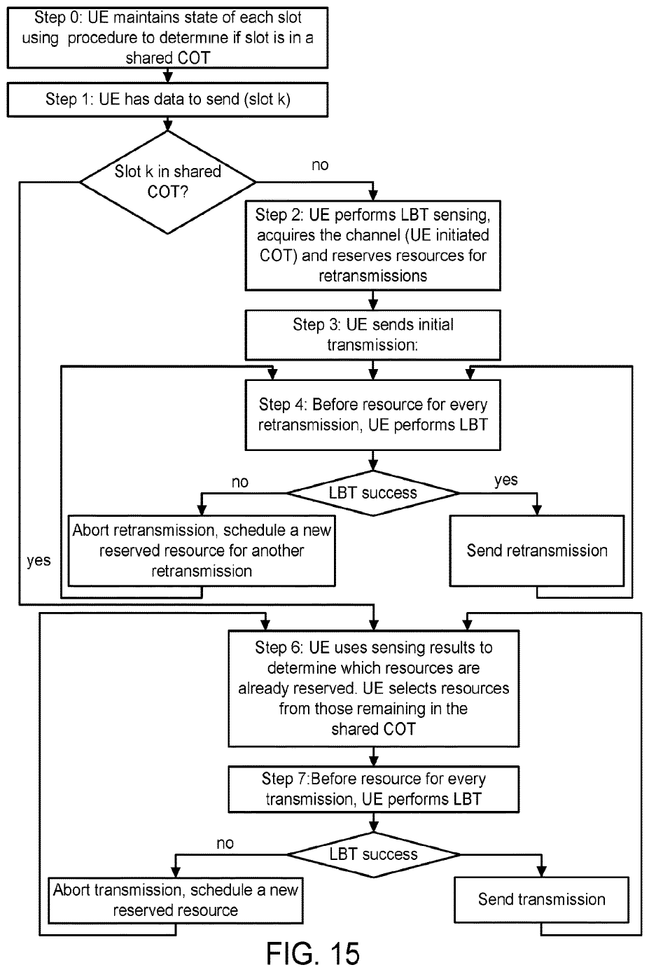

FIG. 15 describes a resource (re)selection model 2. When a UE has SL traffic to send, the UE performs LBT sensing to acquire the channel. Once the channel is acquired, the UE reserves resources for the initial transmission and possible retransmissions. These resources are reserved within the UE COT. The UE may perform LBT sensing before each retransmission within the COT.

Step 0: the UE keeps track of when the channel is acquired by the NR system, by performing the procedure to determine if slot is in a shared COT. In addition the UE does sensing in a sensing window, similar to the procedure for resource (re)selection Model 1. This sensing allows UE to determine the state of the slots, as well as any future reserved resources.

Step 1: when the UE has SL data to send for slot k, UE performs the procedure to determine if slot is in a shared COT. If not, UE proceeds to step 2. If yes, UE may proceed to step 6. As an alternative, the resource (re)selection may be designed to only allow a single UE to transmit during a COT. In such cases, the UE that acquires the COT, is the only UE that is allowed to transmit in the COT. For such an alternative, if the UE determines that the slot is part of a shared COT the UE may go to step 2 as well.

Step 2: UE performs LBT sensing. If successful, UE is said to have acquired the channel. The UE selects resources for the initial transmission and reserves resources for the retransmissions. The UE attempts to perform the retransmission within the UE COT.

Step 3: The UE sends the initial transmission on the selected resource. In the 1^{st} stage SCI of this transmission, the UE may include the reserved resources for the retransmissions.

Step 4: The UE may perform an LBT. If successful, the UE may transmit the retransmission on the reserved resource. If not successful, the UE may abort the retransmission attempt and the MAC may schedule a further retransmission to replace the aborted retransmission. Again, the UE may attempt to keep the retransmission within the UE COT. Step 4 is repeated for all retransmissions to be transmitted in the UE COT.

Step 5: If any retransmissions may not be transmitted in the UE COT, the UE may first wait to determine if the transport block was successfully transmitted (that is, the UE receives an ACKnowledgement from the peer UE). If yes, the further retransmissions may be abandoned and the procedure ends. If no, the first retransmission UE may restart at Step 1 for this transmission.

Step 6: If the current slot is in a shared COT, this may be used as an indication that the channel is already being used by other UEs, and that the channel is acquired by the NR system. The UE may use its sensing results to determine the reserved resources in the current shared COT. The UE may select resources for the initial transmission and reserves resources for the retransmissions. The UE may attempt to reserve the resources from the shared COT.

Step 7: The UE may perform an LBT. If successful, the UE may transmit the transmission on the reserved resource. If not successful, the UE may abort the transmission attempt and the MAC may schedule a further transmission to replace the aborted transmission. Again, the UE may attempt to keep the retransmission within the shared COT. Step 6 is repeated for all transmissions to be transmitted in the shared COT.

Step 8: If any transmissions may not be transmitted in the shared COT, the UE may first wait to determine if the transport block was successfully transmitted (that is, the UE receives an ACKnowledgement from the peer UE). If yes, the further retransmissions are abandoned and the procedure ends. If no, the first retransmission and UE may restart at Step 1 for this transmission.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive recall, disaster alerts, real-time gaming, multi-person video calls, autonomous driving, augmented reality, tactile internet, virtual reality, home automation, robotics, and aerial drones to name a few. All of these use cases and others are contemplated herein.

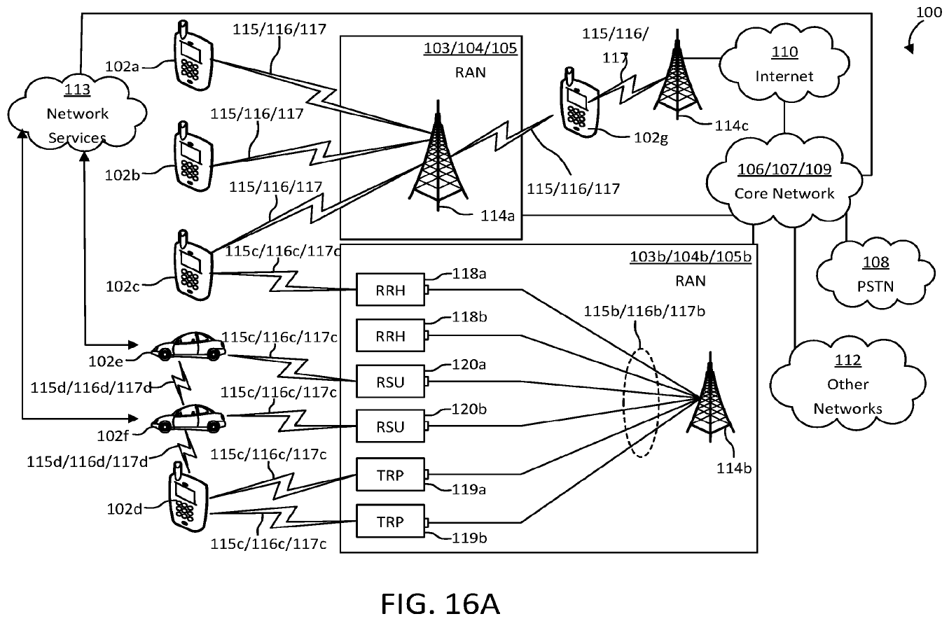

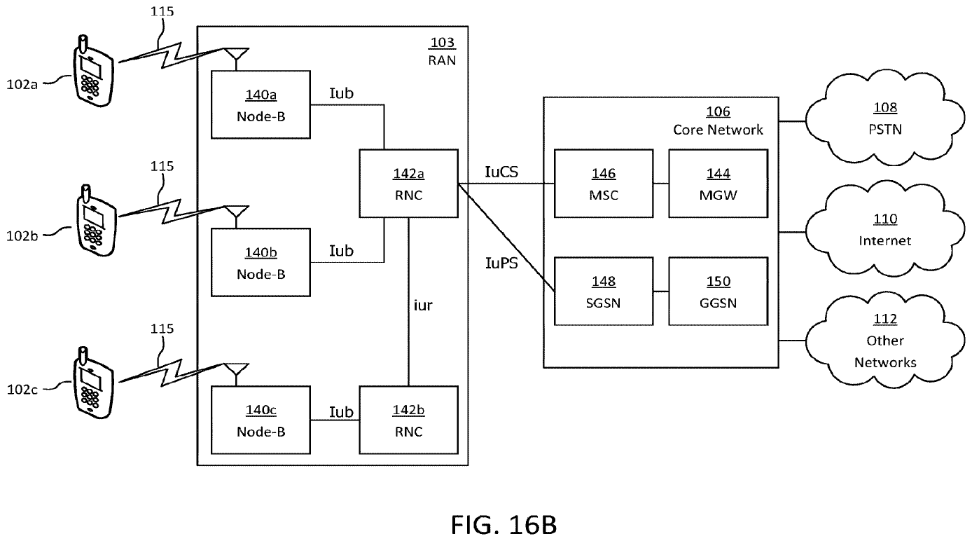

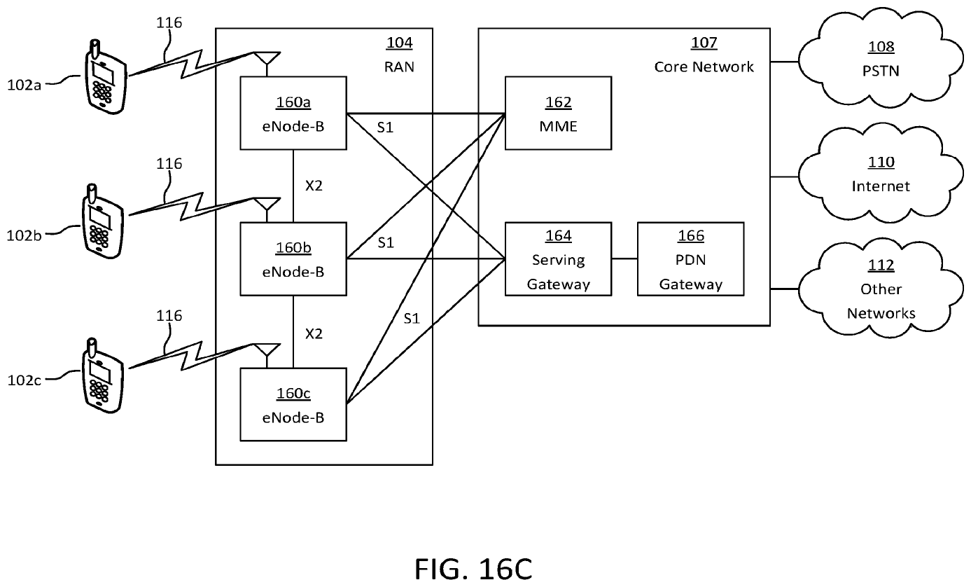

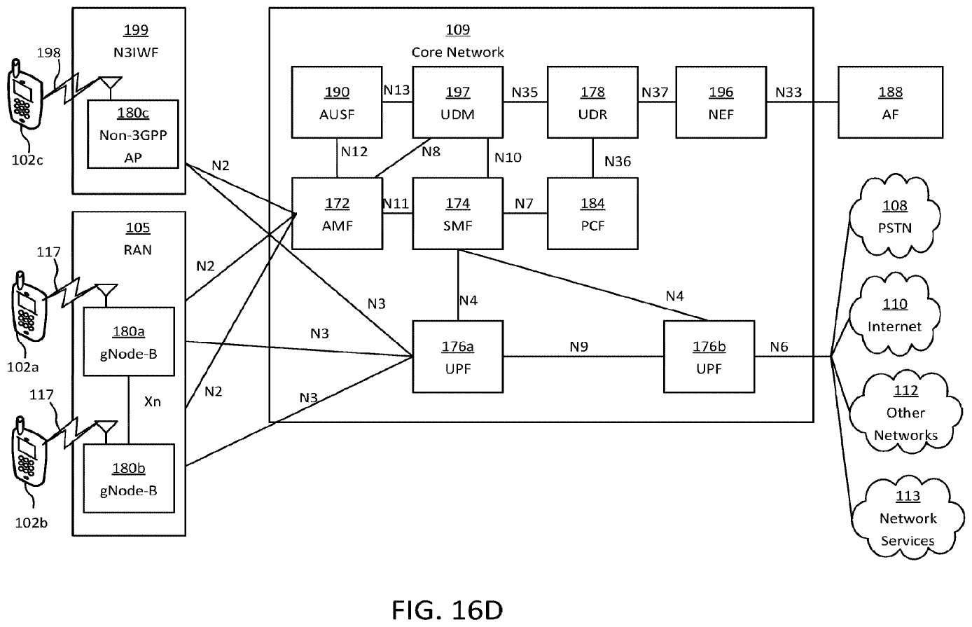

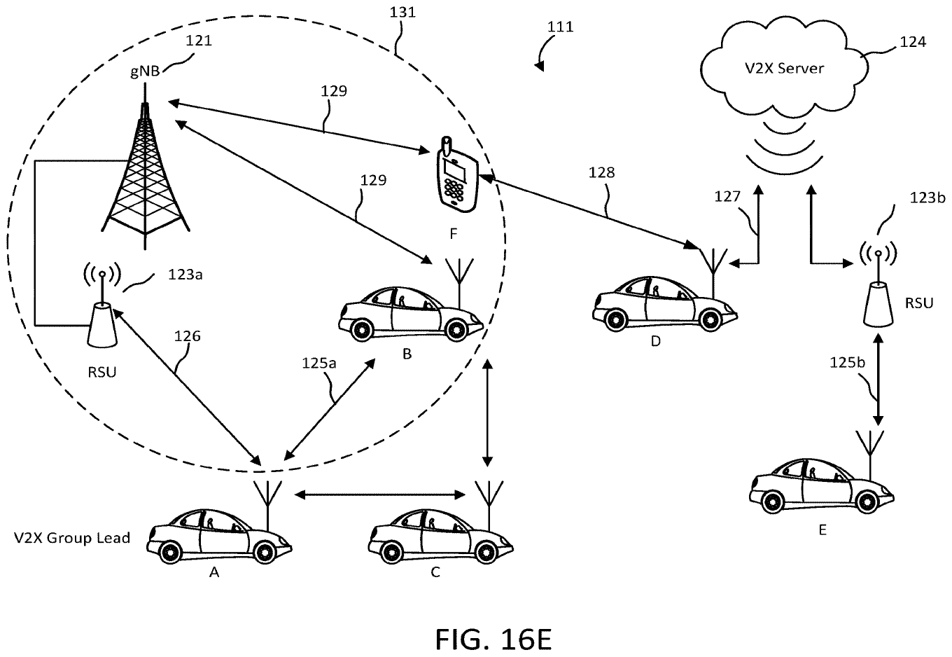

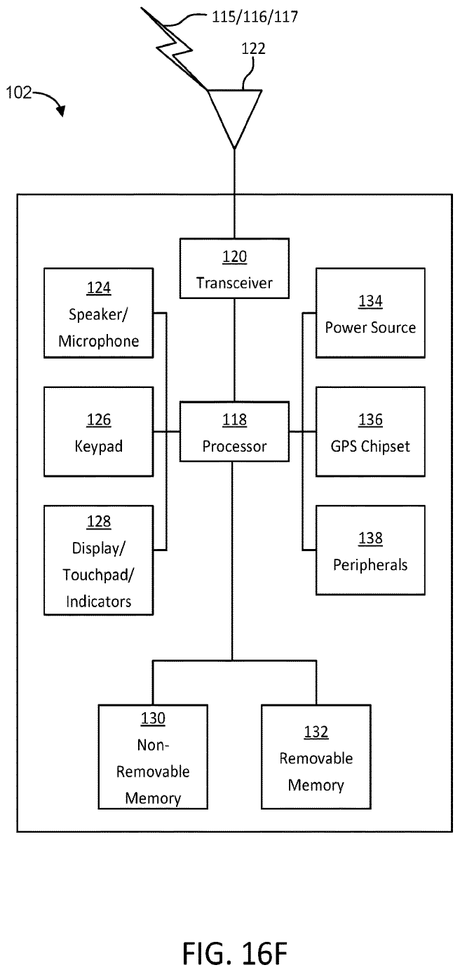

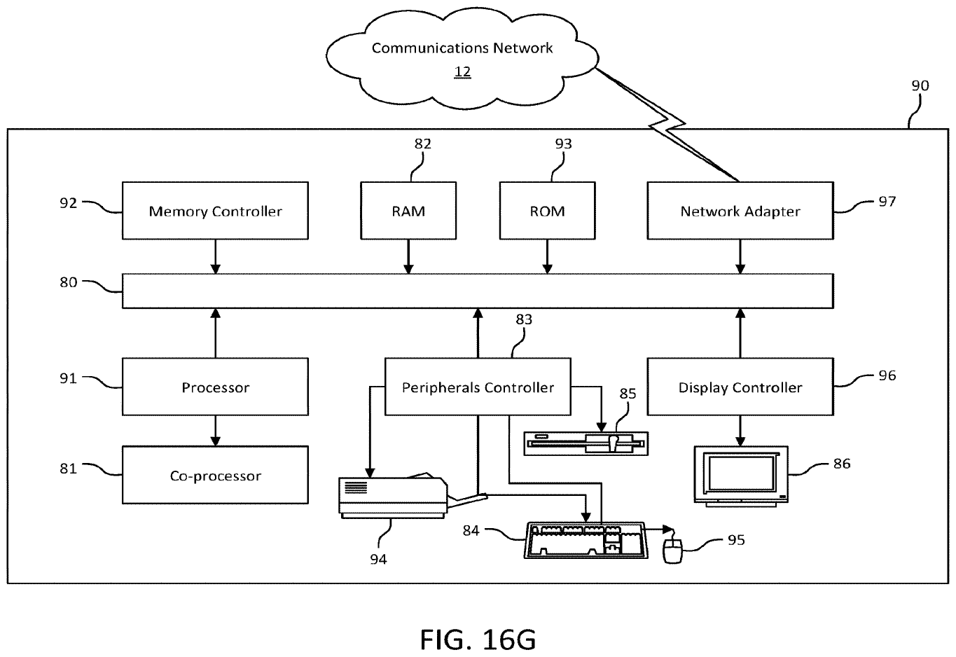

FIG. 16A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 16A, each of the WTRUs 102 is depicted in FIGS. 16A-16E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 16A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wired and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for example.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 16A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 16A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 16A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 16A may be configured to communicate with the base station 114a, which may employ a cellular-based radio technology, and with the base station 114c, which may employ an IEEE 802 radio technology.

Although not shown in FIG. 16A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 16B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 16B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 16B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 16B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 16C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 16C, the eNode-Bs 160a, 160b, and 160c may communicate with one another over an X2 interface.

The core network 107 shown in FIG. 16C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 16D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. The RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 16D, the gNode-Bs 180a and 180b may communicate with one another over an Xn interface, for example.

The core network 109 shown in FIG. 16D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 16G.

In the example of FIG. 16D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 16D shows that network functions directly connect to one another, however, it should be appreciated that they may communicate via routing agents such as a diameter routing agent or message buses.

In the example of FIG. 16D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 16D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 16D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 16D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 16A, 16C, 16D, and 16E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 16A, 16B, 16C, 16D, and 16E are provided by way of example only, and it is understood that the subject matter disclosed and claimed herein may be embodied or implemented in any similar communication system, whether presently defined or defined in the future.

FIG. 16E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 16E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 16E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 16F is a block diagram of an example apparatus or device WTRU 102 that may be configured for wireless communications and operations in accordance with the systems, methods, and apparatuses described herein, such as a WTRU 102 of FIG. 16A, 16B, 16C, 16D, or 16E. As shown in FIG. 16F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 16F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 16F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 16A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 16F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 16G is a block diagram of an exemplary computing system 90 in which one or more apparatuses of the communications networks illustrated in FIGS. 16A, 16C, 16D and 16E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 16A, 16B, 16C, 16D, and 16E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1.-15. (canceled)

16. A first wireless transmit/receive unit (WTRU) comprising:
a processor configured to:
receive channel occupancy time (COT) sharing information, wherein the COT sharing information comprises an indication of a second WTRU that initiated the COT, a remaining time associated with the COT, and an indication of one or more restrictions related to the COT;
determine at least one transmit opportunity for sidelink transmission based on the COT sharing information;
perform listen-before-talk (LBT) sensing based on the COT sharing information; and
send a sidelink transmission over the determined transmit opportunity based on the determination that the LBT sensing is successful.

17. The first WTRU of claim 16, wherein the one or more restrictions comprise one or more cast types permitted using the COT.

18. The first WTRU of claim 17, wherein the one or more cast types comprises a unicast cast type or a multicast cast type.

19. The first WTRU of claim 16, wherein the one or more restrictions comprise a destination identification or a source identification.

20. The first WTRU of claim 19, wherein the destination identification comprises a destination layer 2 identifier (ID).

21. The first WTRU of claim 19, wherein the source identification comprises a source layer 2 identifier (ID).

22. The first WTRU of claim 16, wherein the processor is configured to:
determine an occurrence of a physical sidelink feedback channel (PSFCH) that partially or fully within a shared COT; and
determine a duration of the shared COT or an end of the shared COT.

23. The first WTRU of claim 22, wherein the processor is configured to maintain information on a state of the PSFCH, wherein the information comprises whether the PSFCH is being used as part of the shared COT.

24. The first WTRU of claim 16, wherein the processor is configured to send hybrid automatic repeat request (HARQ) feedback after receiving all of retransmissions of transport block.

25. The first WTRU of claim 24, wherein the processor is configured to determine a PSFCH to associate with a burst transmission of the transport block, wherein the processor is further configured to use the PSFCH associated with a first received transport block or a last received transport block of the burst.

26. A method implemented by a first wireless transmit/receive unit (WTRU), the method comprising:
receiving channel occupancy time (COT) sharing information, wherein the COT sharing information comprises an indication of a second WTRU that initiated the COT, a remaining time associated with the COT, and an indication of one or more restrictions related to the COT;
determining at least one transmit opportunity for sidelink transmission based on the COT sharing information;
performing listen-before-talk (LBT) sensing based on the COT sharing information; and
sending a sidelink transmission over the determined transmit opportunity based on the determination that the LBT sensing is successful.

27. The method of claim 26, wherein the one or more restrictions comprise one or more cast types permitted using the COT.

28. The method of claim 27, wherein the one or more cast types comprises a unicast cast type or a multicast cast type.

29. The method of claim 26, wherein the one or more restrictions comprise a destination identification or a source identification.

30. The method of claim 29, wherein the destination identification comprises a destination layer 2 identifier (ID).

31. The method of claim 29, wherein the source identification comprises a source layer 2 identifier (ID).

32. The method of claim 26, further comprising:
determining an occurrence of a physical sidelink feedback channel (PSFCH) that partially or fully within a shared COT; and
determining a duration of the shared COT or an end of the shared COT.

33. The method of claim 32, further comprising maintaining information on a state of the PSFCH, wherein the information comprises whether the PSFCH is being used as part of the shared COT.

34. The method of claim 26, further comprising sending hybrid automatic repeat request (HARQ) feedback after receiving all of retransmissions of transport block.

35. The method of claim 34, further comprising determining a PSFCH to associate with a burst transmission of the transport block, wherein further comprising using the PSFCH associated with a first received transport block or a last received transport block of the burst.
